(19) United States
(12) Patent Application Publication
(10) Pub. No.: US 2011/0249280 A1
(43) Pub. Date: Oct. 13, 2011

(54) METHOD FOR MANUFACTURING PRINTING DEVICE

(75) Inventor: Takashi ITO, Matsumoto-shi (JP)

(73) Assignee: SEIKO EPSON CORPORATION, Tokyo (JP)

(21) Appl. No.: 13/045,901

(22) Filed: Mar. 11, 2011

(30) Foreign Application Priority Data
Apr. 12, 2010 (JP) 2010-091480

(51) Int. Cl. H04N 1/60

(52) U.S. Cl. 358/1.9

(57) ABSTRACT

A method for manufacturing a printing device includes: performing a linear transformation for transforming ink quantities in an ink color coordinate system corresponding to coordinate values in an input color coordinate system into a virtual color space, which has ink quantity vectors oriented in mutually different directions in the respective chroma value spaces of the plurality of inks as basis vectors, with reference to substitution ratio vectors; determining the ink quantities by carrying out a plurality of iterations of optimization using a predetermined objective function represented by a combination of individually weighted picture quality evaluation indices in the virtual color space; creating a color transformation table based on the optimized ink quantities; and recording the color transformation table to a recording medium of the printing device.

### CROSS-REFERENCE TO RELATED APPLICATIONS

This application claims priority to Japanese Patent Application No. 2010-091480 filed on Apr. 12, 2010. The entire disclosure of Japanese Patent Application No. 2010-091480 is hereby incorporated herein by reference.

### BACKGROUND

1. Technical Field

The present invention relates to a technique for manufacturing a printing device provided with a color transformation table, and relates in particular to creation of a color transformation table for transforming coordinate values in an input color coordinate system to ink quantities in an ink color coordinate system which is composed of a plurality of ink types.

2. Related Art

In the field of printing devices such as color inkjet printers, which have come to enjoy widespread use in recent years, it is known to supplement inks of the colors cyan (C), magenta (M), yellow (Y), and black (K) with inks such as orange (Or), green (Gr), blue (B), red (R), and violet (V), termed special color inks, in order to expand the range of color reproduction. Cyan (C), magenta (M), and yellow (Y) are called primary chromatic color inks, while special color inks such as Or, Gr, B, R, and V are called secondary chromatic color inks. Secondary chromatic color refers to colors that can be decomposed into two primary chromatic color components.

Ink quantities of inks that may be used in a printing device are determined according to the given colors of the color image, and a color separation process is carried out in order to determine ink quantities of the inks to be used during printing for the purpose of such color reproduction. Relationships between color ink quantities and color data of color images are typically stored beforehand in a color transformation table (color transformation lookup table (LUT)), and during printing, ink quantities of each color are determined for each pixel location according to the color transformation table. This color separation process is also termed an ink color decomposition process. Japanese Laid-Open Patent Publication No. 2008-302699 discloses a color separation process adapted to carry out color separations of input colors composed of primary colors (CMY) into ink quantity sets that include primary color inks and secondary color inks.

### SUMMARY

As noted above, according to Japanese Laid-Open Patent Publication No. 2008-302699, an input color is transformed to a primary color system represented by CMY, and the color represented by CMY then undergoes color separation to a reproduction color system represented by CMYRV. Specifically, color separation from input color to reproduction color takes place at a non-negative substitution ratio. For this reason, substitution of ink quantities is carried out such that the color originally represented in the input color is represented by the reproduction color, resulting in an inability to fully utilize the expanded color reproduction gamut that is possible through supplementation with special color inks.

It is an object of the present invention to provide a method for manufacturing a printing device provided with a color transformation table whereby color separation is possible in a manner that fully utilizes the color reproduction range of an ink quantity set that includes special color inks, during color separation of coordinate values in an input color coordinate system into the ink quantity set.

In order to address the above problem at least in part, a method according to an aspect of the present invention is a method for manufacturing a printing device provided with a color transformation table for transformation of coordinate values in an input color coordinate system indicated by input image data to ink quantity sets in an ink color coordinate system composed of a plurality of inks. The method includes: performing a linear transformation for transforming ink quantities in the ink color coordinate system corresponding to the coordinate values in the input color coordinate system into a virtual color space with reference to substitution ratio vectors for transforming the ink quantities into the virtual color space, the virtual color space having ink quantity vectors oriented in mutually different directions in the respective chroma value spaces of the plurality of inks as basis vectors; optimizing the ink quantities by carrying out a plurality of iterations of optimization using a predetermined objective function that is represented by a combination of a plurality of individually weighted picture quality evaluation indices in the virtual color space; creating a color transformation table for transformation of the coordinate values in the input color coordinate system to the ink quantities in the ink color coordinate system, based on the optimized ink quantities; and recording the color transformation table in computer-readable form to a recording medium of the printing device.

According to the configuration set forth above, even ink quantity sets that can only be represented as negative values in the virtual color space may be targeted for optimization in the optimization step, and ink quantities in the ink color coordinate system that correspond to coordinate values in the input color coordinate system can be determined in the optimization step, while utilizing to the full extent the color reproduction range that is reproducible with the ink quantity sets. Ink quantity sets generated by carrying out color transformation based on the color transformation table created in this way allow the color reproduction range that is reproducible with the aforementioned ink quantity sets to be utilized to the full extent.

The present invention may be reduced to practice in various modes, examples thereof being a color transformation table creating device, a smoothing/optimization process method and device, a manufacturing method and a manufacturing system for a printing device that incorporates a color transformation table in the printing device, a computer program for accomplishing the functions of such methods or devices, a recording medium having the computer program recorded thereon, and the like. The utility of the present invention may also be realized in a printing device incorporating a color transformation table.

### BRIEF DESCRIPTION OF THE DRAWINGS

Referring now to the attached drawings which form a part of this original disclosure:

FIG. 1 is a block diagram showing a configuration of a lookup table creation device according to an embodiment of the present invention.

FIG. 2 is a flowchart showing the entire process sequence of the embodiment.

FIG. 3 is an illustration showing process specifics in a case of creating a base 3D-LUT by Steps S100 to S300 of FIG. 2.

FIG. 4 is an illustration showing a correspondence relationship between color points in an RGB color coordinate system which is an input color coordinate system, and color points in an Lab color coordinate system.

FIG. 5 is an illustration showing process specifics in a case of creating a base 4D-LUT by Steps S100 to S300 of FIG. 2.

FIG. 6 is an illustration showing a method for creating a color correction LUT using a base LUT.

FIG. 7 is a flowchart showing a sequence for creating a substitution ratio matrix.

FIG. 8 is a flowchart showing a sequence for creating ink generation point control parameters.

FIG. 9 is a diagram showing a relationship of a coefficient vector α and a duty limit when C ink is substituted by a combination of three colors.

FIG. 10 is a drawing explaining Equation (8).

FIG. 11 is an illustration showing a dynamic model utilized in the smoothing process of the embodiment.

FIG. 12 is a flowchart showing a typical process sequence of a smoothing process.

FIG. 13 is a flowchart showing in detail the sequence of Step T100 of FIG. 12.

FIG. 14 is an illustration showing process specifics of Steps S120 to S150 of FIG. 12.

FIG. 15 is a flowchart showing in detail the sequence of the optimization process (Step T130 of FIG. 8).

### DETAILED DESCRIPTION OF EXEMPLARY EMBODIMENTS

The embodiments of the present invention are described below, in the following order: (1) Device Configuration and Overall Process Sequence; (2) Substitution Ratio Matrix Creation Sequence; (3) Creation Sequence for Limit Parameters of Ink Generation Point; (4) Dynamic Model; (5) Process Sequence of Smoothing Process (Smoothing/optimization Process); (6) Specifics of Optimization Process; and (7) Modified Examples:

### (1) Device Configuration and Overall Process Sequence

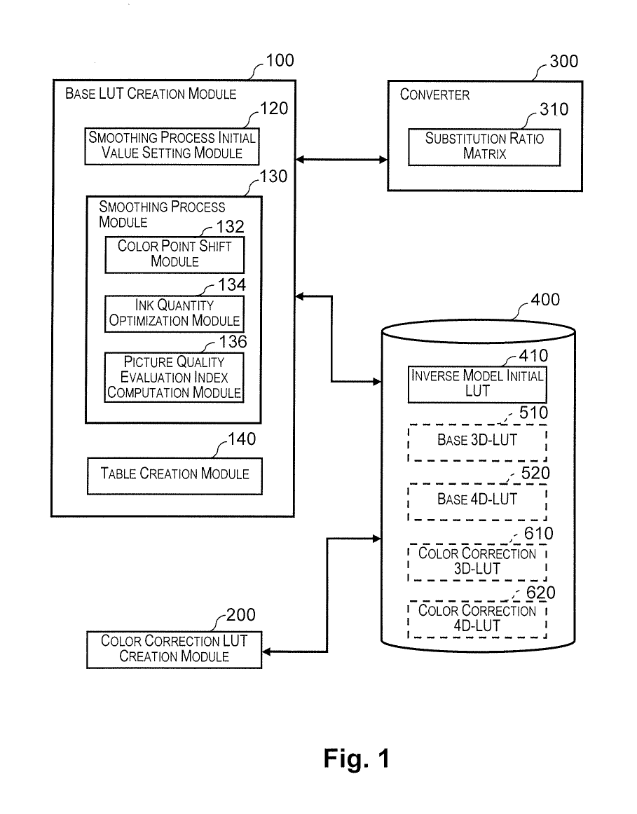

FIG. 1 is a block diagram showing a configuration of a lookup table creation device according to an embodiment of the present invention. This device includes a base LUT creation module 100, a color correction LUT creation module 200, a converter 300, and an LUT storage portion 400. “LUT” is an abbreviation of lookup table, which is provided as a color transformation profile. The functions of these modules 100, 200 and of the converter 300 are respectively realized through execution by a computer of a computer program that is stored in memory. The LUT storage portion 400 is realized by a recording medium such as a hard disk device.

The base LUT creation module 100 has a smoothing process initial value setting module 120 and a table creation module 140. A smoothing process module 130 has a color point shift module 132, an ink quantity optimization module 134, and a picture quality evaluation index computation module 136. The converter 300 transforms ink quantity sets to virtual CMY data based on the converter 300, discussed later. The functions of these parts will be discussed later.

The LUT storage portion 400 stores an inverse model initial LUT 410, a base 3D-LUT 510, a base 4D-LUT 520, a color correction 3D-LUT 610, a color correction 4D-LUT 620, and so on. The LUTs, apart from the inverse model initial LUT 410, are created by the base LUT creation module 100 or the color correction LUT creation module 200.

The base 3D-LUT 510 is a color transformation lookup table having an RGB color coordinate system as input, and ink quantities as output. The base 4D-LUT 520, on the other hand, is a color transformation lookup table having a CMYK color coordinate system as input, and ink quantities as output. “3D” and “4D” refer to the number of input values. These base LUTs 510, 520 are used, for example, during creation of the color correction LUTs 610, 620. The name “base LUT” is used because they serve as bases for creating color correction LUTs.

The color correction LUTs 610, 620 are lookup tables for transforming a standard device-dependent color coordinate system (e.g., the sRGB color coordinate system or the JAPAN COLOR 2001 color coordinate system) to ink quantities for a specific printer. The inverse model initial LUT 410 is discussed later.

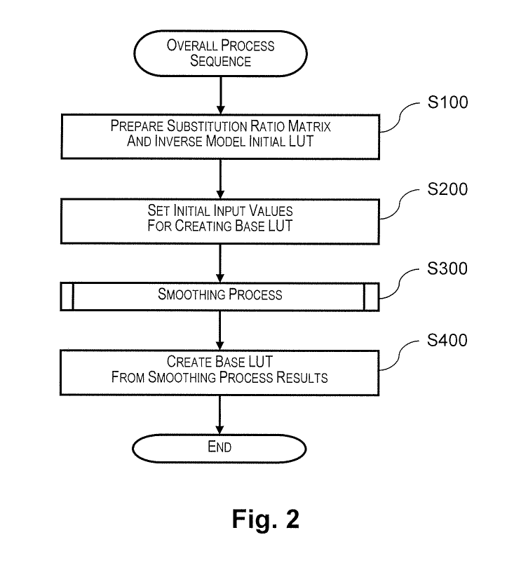

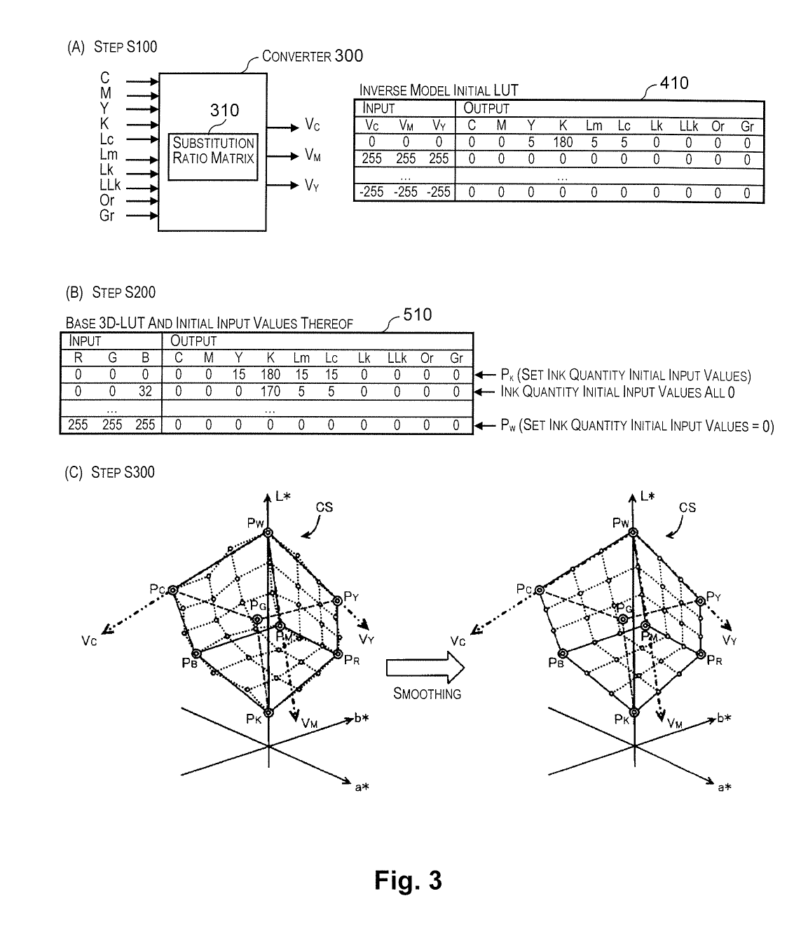

FIG. 2 is a flowchart showing the entire process sequence of the embodiment. FIGS. 3(A) to (C) are illustrations showing process specifics in a case of creating a base 3D-LUT by Steps S100 to S300 of FIG. 2. In Step S100, a substitution ratio matrix 310 and the inverse model initial LUT 410 are prepared. Here, “inverse model” refers to a transformation model for transforming values in a virtual space, discussed later, to ink quantities. In the present embodiment, the CIE-Lab color coordinate system is used as a device-independent color coordinate system. Herein, the chroma values of the CIE-Lab color coordinate system are denoted simply as “L*a*b* values” or “Lab values”.

As shown in FIG. 3(A), the converter 300, referring to the substitution ratio matrix 310, transforms the ink quantities of a plurality of ink types to V_{C}, V_{M}, V_{Y}, which represent color points in a virtual CMY space which is a virtual color space. Herein, the color points V_{C}, V_{M}, V_{Y} in the virtual CMY space shall be termed virtual CMY values. The present embodiment assumes the color printer is able to utilize 10 types of ink, namely, cyan (C), magenta (M), yellow (Y), black (K), light cyan (Lc), light magenta (Lm), light black (Lk), light light black (LLk), orange (Or), and green (Gr); the converter 300 transforms ink quantities of these 10 inks to color points in the virtual CMY space. However, it is possible to use any ink set as the plurality of ink types used by the printer. Also, the virtual color space which is output by the converter 300 may be a virtual color space other than CMY, such as one composed of LcLmY or the like; or a virtual color space composed of any three inks selected from among the plurality of inks installed in the printer. Design of the virtual color space is discussed in detail later.

The inverse model initial LUT 410 is a lookup table having virtual CMY values as input, and ink quantities as output. In this initial LUT 410, for example, the virtual CMY space is divided into a plurality of small cells, and appropriate ink quantities selected on an individual small cell basis are registered in the table. This selection may be made with consideration to the picture quality of color patches that have been printed out using those ink quantities, for example. Typically, there are a multitude of ink quantity combinations for reproducing a single given virtual CMY value. Accordingly, ink quantities that are optimal from a desired standpoint, such as picture quality, selected from among a multitude of ink quantity combinations for reproducing substantially identical virtual CMY values are registered in the initial LUT 410. The virtual CMY values which are the input values to the initial LUT 410 are representative values of the small cells. On the other hand, the ink quantities which are the output values are values that reproduce any virtual CMY in the cell. Consequently, in the initial LUT 410, there is not always rigorous correspondence between the input virtual CMY value and the output ink quantities, and when the output ink quantities are transformed to virtual CMY values by the converter 300, values that differ in varying degrees from the initial LUT 410 input values are obtained. However, input values and output values that are in complete correspondence may be utilized for the initial LUT 410. It is also possible to create a base LUT without using the initial LUT 410. As the method for selecting optimal ink quantities for individual small cells to create the initial LUT 410, it is possible, for small cells of an L*a*b* space corresponding to the small cells of the virtual CMY space, to select ink quantities by employing, for example, the method disclosed in Japanese Unexamined Patent Application (Translation of PCT Application) 2007-511175, and to associate these quantities with the small cells of the virtual CMY space in order to create the table. With regard to the ink quantities registered in the inverse model initial LUT as well, these quantities may be created while applying a generation point control parameter that is created from the substitution ratio matrix, discussed later.

In Step S200 of FIG. 2, initial input values for base LUT creation are set by the user. FIG. 3(B) shows an example of a configuration of the base 3D-LUT 510 and initial input value settings thereof. Substantially equidistantly spaced values predetermined as RGB values are set as input values for the base 3D-LUT 510. Because one set of RGB values is considered to represent a point in the RGB color space, one set of RGB values is also termed an “input lattice point.” In Step S200, ink quantity initial values for a small number of input lattice points preselected from among the plurality of input lattice points are input by the user. In preferred practice, at a minimum, input lattice points that correspond to vertex points of a three-dimensional color solid in the RGB color space will be selected as the input lattice points to be set by these initial input values. RGB values assume their minimum value or maximum value within their defined range at the vertex points of this three-dimensional color solid. Specifically, where RGB values are represented on eight bits, initial input values of ink quantities are set in relation to the eight input lattice points (R, G, B)=(0, 0, 0), (0, 0, 255), (0, 255, 0), (255, 0, 0), (0, 255, 255), (255, 0, 255), (255, 255, 0), and (255, 255, 255). Ink quantities for the input lattice point (R, G, B)=(255, 255, 255) are all set to zero. Initial input values of ink quantities for the other input lattice points may be set arbitrarily, for example, to zero. In the example of FIG. 3(B), ink quantities for the input lattice point (R, G, B)=(0, 0, 32) are values other than zero, but these are the values obtained when this LUT 510 is completed.

In Step S300 of FIG. 2, the smoothing process module 130 (FIG. 1) executes a smoothing process (smoothing/optimization process) based on the initial input values that were set in Step S200. FIG. 3(C) shows the specifics of the process of Step S300. The distribution of a plurality of color points in the state prior to smoothing is shown by double circles and white circles at the left side in FIG. 3(C). These color points make up a three-dimensional color solid CS in a virtual CMY space. This three-dimensional color solid CS correlates with a three-dimensional color solid in the Lab space, and the drawing also shows the axes of the Lab space which corresponds to the virtual CMY space. The virtual CMY coordinate values of the color points are values derived by transformation of ink quantities in a plurality of input lattice points of the base 3D-LUT 510 to virtual CMY values using the converter 300 (FIG. 3(A)). As mentioned above, in Step S200, initial input values of ink quantities are set only for a small number of input lattice points. Initial values of ink quantities for the other input lattice points are set from the initial input values by the smoothing process initial value setting module 120 (FIG. 1). This initial value setting method is discussed later.

The three-dimensional color solid CS of the virtual CMY space has the following eight vertex points (the double circle points in FIG. 3(C)).
Point P_{K}: paper black point corresponding to (R, G, B)=(0, 0, 0)
Point P_{W}: paper white point corresponding to (R, G, B)=(255, 255, 255)
Point P_{C}: cyan point corresponding to (R, G, B)=(0, 255, 255)
Point P_{M}: magenta point corresponding to (R, G, B)=(255, 0, 255)
Point P_{Y}: yellow point corresponding to (R, G, B)=(255, 255, 0)
Point P_{R}: red point corresponding to (R, G, B)=(255, 0, 0)
Point P_{G}: green point corresponding to (R, G, B)=(0, 255, 0)
Point P_{B}: blue point corresponding to (R, G, B)=(0, 0, 255)

The distribution of color points subsequent to the smoothing process is shown at the right side in FIG. 3(C). The smoothing process is a process for shifting the plurality of color points in the virtual CMY space to make the distribution of the color points a smooth one that approximates equidistant spacing. In the smoothing process, optimal ink quantities for reproducing the virtual CMY values of the shifted color points are determined as well. Upon registering these optimal ink quantities as output values into the base LUT 510, the base LUT 510 is complete.

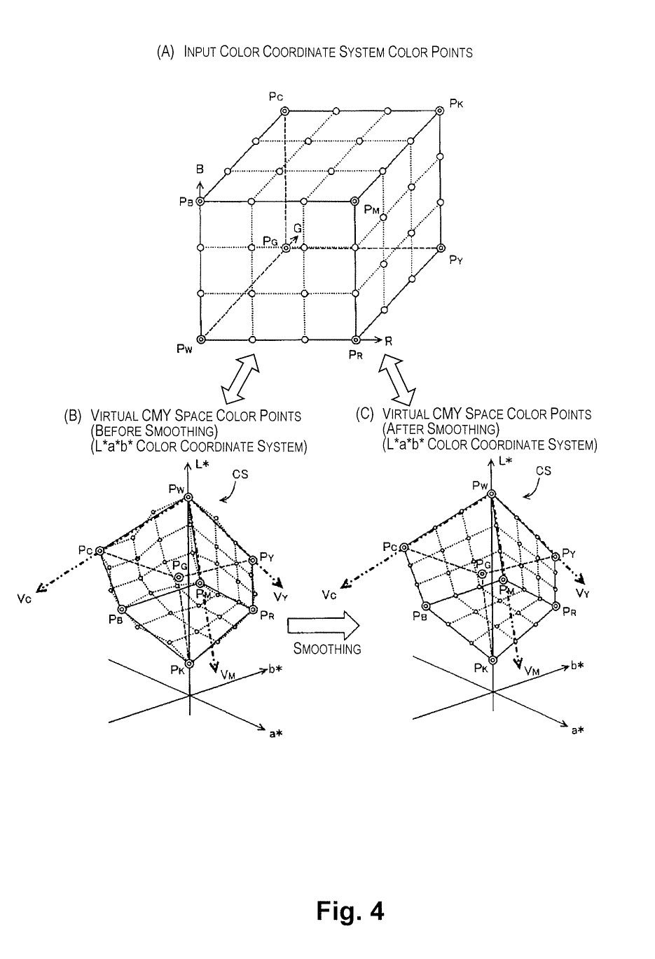

FIGS. 4(A) to (C) show a correspondence relationship between color points in the input color coordinate system (i.e., input lattice points) and color points in the virtual CMY space. The vertex points of the three-dimensional color solid CS of the virtual CMY space have one-to-one correspondence with the vertex points of the three-dimensional color solid of the input color coordinate system of the base LUT 510. The sides which connect the vertex points (the edges) can also be considered to correspond to one another between the two solids. The color points of the virtual CMY space prior to the smoothing process are respectively associated with the input lattice points of the base LUT 510, and consequently the color points of the virtual CMY space subsequent to the smoothing process likewise are respectively associated with the input lattice points of the base LUT 510. The input lattice points of the base LUT 510 are unchanged by the smoothing process. The three-dimensional color solid CS of the virtual CMY space subsequent to the smoothing process corresponds to the entirety of the color gamut reproducible by the ink set that makes up the output color coordinate system of the base LUT 510. Consequently, the input color coordinate system of the base LUT 510 has the significance of being a color coordinate system representing the entirety of the color gamut reproducible by this ink set.

The reason for carrying out the smoothing process in the virtual CMY space during creation of the base LUT 510 is as follows. In the base LUT 510, it is desirable to set the ink quantities of the output color coordinate system in such a way as to be able to reproduce the largest possible color gamut. The color gamut reproducible by a particular ink set is determined with consideration to predetermined limiting parameters such as the ink duty limit (the limit of the quantity of ink ejectable on a given surface area). The substitution ratio matrix 310 mentioned earlier is created independently of the reproducible color gamut, with no consideration to these limiting parameters. In this regard, by taking into consideration limiting parameters such as the ink duty limit during the smoothing process when determining the possible range for the color points in the virtual CMY space, it is possible to determine the reproducible color gamut of a particular ink set. The algorithm used for carrying out shifting of the color points may utilize, for example, the dynamic model described later.

In Step S400 of FIG. 2, the table creation module 140 uses the results of the smoothing process to create the base LUT 510. Specifically, as the output values in the base LUT 510 (FIG. 3(C)), the table creation module 140 registers optimal ink quantities for reproducing color points in the virtual CMY space associated with the input lattice points. In order to reduce the computational load in the smoothing process, it is possible to select, as targets for processing, only those color points that correspond to only certain of the input lattice points of the base LUT 510. For example, where the RGB values in the input lattice points of the base LUT 510 have an interval of 16, by setting an interval of 32 for the RGB values in the input lattice points targeted for the smoothing process, the load associated with the smoothing process may be reduced by half. In this case, the table creation module 140 registers ink quantities determined for all of the input lattice points of the base LUT 510 by interpolating the smoothing process results.

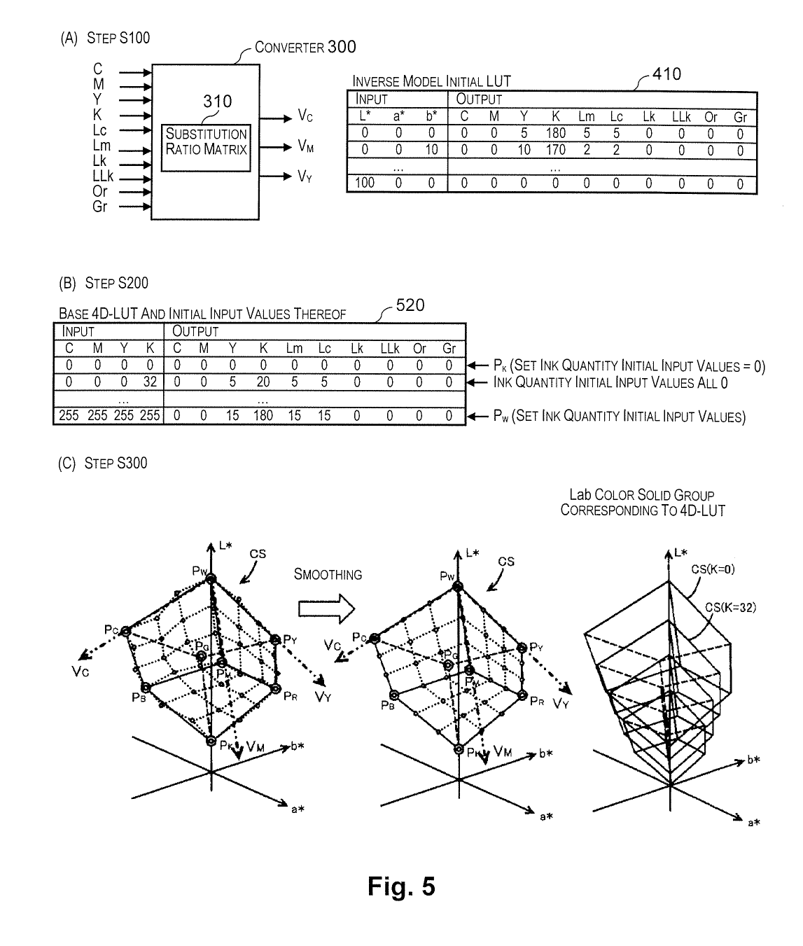

FIGS. 5(A) to (C) are illustrations showing process specifics in a case of creating the base 4D-LUT 520 by Steps S100 to S300 of FIG. 2. FIG. 5(A) is identical to FIG. 3(A). The base 4D-LUT 520 shown in FIG. 5(B) differs from the base 3D-LUT 510 shown in FIG. 3(B) in that the input is the CMYK color coordinate system. As the initial input values of this base 4D-LUT 520, initial values of ink quantities are set in relation to the 16 input lattice points (C, M, Y, K)=(0, 0, 0, 0), (0, 0, 255, 0), (0, 255, 0, 0), (0, 255, 255, 0), (255, 0, 0, 0), (255, 0, 255, 0), (255, 255, 0, 0), (255, 255, 255, 0), (0, 0, 0, 255), (0, 0, 255, 255), (0, 255, 0, 255), (0, 255, 255, 255), (255, 0, 0, 255), (255, 0, 255, 255), (255, 255, 0, 255), and (255, 255, 255, 255). Initial input values of ink quantities for other input lattice points are set arbitrarily, for example, to zero.

Conditions in the smoothing process are shown in FIG. 5(C). As shown at the right end of FIG. 5(C), as color solids corresponding to the base 4D-LUT 520 in the virtual CMY space, there exist one three-dimensional color solid CS for each of the respective values of the K value among the input values. This example shows a plurality of color solids CS including a color solid associated with K=0 and a color solid associated with K=32. In the present specification, these individual color solids CS are also referred to as “K layers.” The reason is that each of the color solids CS may be thought of as corresponding to an input layer in which, of the CMYK values, the K value is constant and the C, M, and Y values are variable. The plurality of color solids CS represents progressively darker color gamuts for greater K values. The plurality of color solids CS can be realized by determining the ink quantity of dark black ink K such that the ink quantity of dark black ink K increases with greater K values of the input color coordinate system. As mentioned above, the reproducible color gamut is limited by the ink duty limit value. Typically, the ink duty limit value imposes two limit values, i.e., the ink quantities of individual inks, and the total ink quantity of all of the inks. Possible methods for reproducing dark colors are methods involving the use of achromatic ink such as dark black ink K, and methods involving the use of composite black. However, with composite black, the total quantity of ink is greater, thereby making it more likely to come up against the ink duty limit value as compared with dark black ink K, which is a disadvantage in terms of reproducing dark colors. Consequently, color solids having greater K values of the input color coordinate system and more dark black ink K are able to reproduce darker colors than are color solids having smaller K values of the input color coordinate system and less dark black ink K.

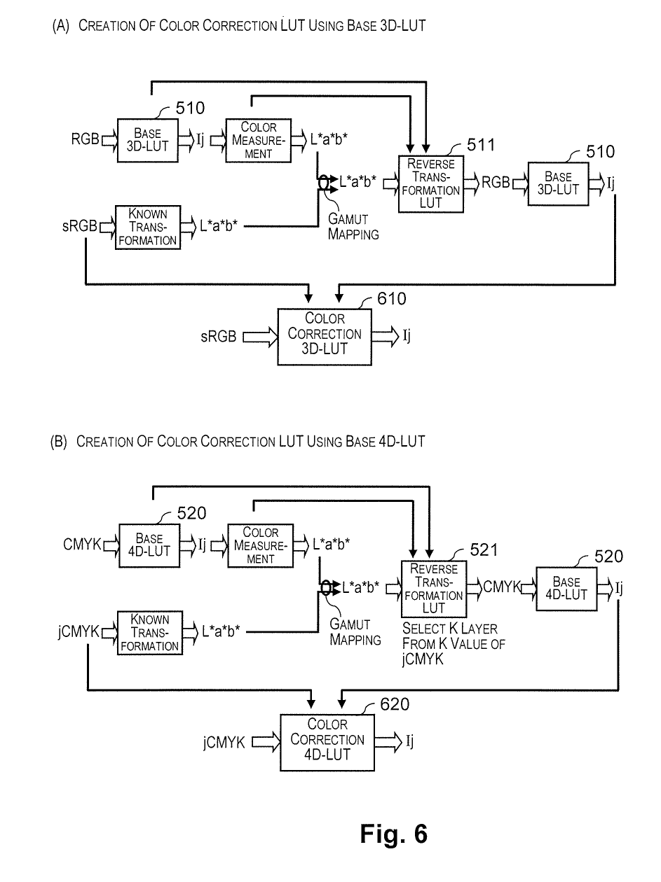

FIGS. 6(A) and (B) are illustrations showing a method for creating a color correction LUT using a base LUT. As shown in FIG. 6(A), the base 3D-LUT 510 transforms RGB values to ink quantities Iⱼ. The ink quantities Iⱼ represent ink quantities of the 10 types of ink shown in FIG. 3(B). Here, the subscript j of the ink quantity Iⱼ is a number from 1 to 10. The transformed ink quantities Iⱼ are transformed to L*a*b* values through color measurement. Specifically, color patches are printed with the transformed ink quantities Iⱼ onto printing paper corresponding to the base 3D-LUT 510 or the base 4D-LUT 520, and the printed color patches are measured with a colorimeter or the like in order to acquire Lab color coordinate system chroma values of the color patches that were printed out according to the ink quantities Iⱼ in question. When acquiring the chroma values, a preselected illuminant (e.g., the D50 standard illuminant) is employed as a color patch observation parameter. In the present specification, the term “color patch” is not limited to patches of chromatic color, but is used in a broad sense to include patches of achromatic color.

Meanwhile, the sRGB values are transformed to L*a*b* values according to a known transformation equation. The transformed L*a*b* values undergo gamut mapping such that the gamut thereof matches the gamut of the L*a*b* values obtained through color measurement of the color patches that were printed at the ink quantities Iⱼ transformed using the base 3D-LUT. Meanwhile, a reverse transformation LUT 511 is created as a reverse direction lookup table, from the L*a*b* values transformed from RGB values using the base 3D-LUT 510 and the aforementioned color measurement. The gamut-mapped L*a*b* values are transformed to RGB values by this reverse transformation LUT 511. These RGB values are then further transformed back into ink quantities Iⱼ by the base 3D-LUT 510. The color correction 3D-LUT 610 can be created through registration of correlation relationships between these final ink quantities Iⱼ and the initial sRGB values in a lookup table. The color correction 3D-LUT 610 is a color transformation table for transforming the sRGB color coordinate system to the ink color coordinate system.

FIG. 6(B) shows a method of creating the color correction 4D-LUT 620. The differences from FIG. 6(A) are that the base 4D-LUT 520 and a reverse transformation LUT 521 thereof are used in place of the base 3D-LUT 510 and the reverse transformation LUT 511 thereof, and that a known transformation equation for transformation of the JAPAN COLOR color coordinate system (in the drawings, denoted as “jCMYK”) to L*a*b* values is used in place of the known transformation equation for transformation of the sRGB color coordinate system to the L*a*b* color coordinate system. As is well known, JAPAN COLOR is a color coordinate system composed of the four colors CMYK. In the method of FIG. 6(B), when converting from L*a*b* values to CMYK values in the reverse transformation LUT 521, a K layer of the reverse transformation LUT 521 (a portion thereof in which the K value is constant) is selected from the K values of the initial jCMYK values prior to the known transformation. Consequently, it is possible to create a color correction 4D-LUT 620 that reflects the characteristics of the K layer in the base 4D-LUT 520. Step S400 executed by the table creation module 140 in the above manner constitutes the color transformation table creation step in the present embodiment.

Typically, the base LUTs 510, 520 are provided to the printer driver, and are utilized in other processes besides the color correction LUT creation process; however, other examples of utilization will not be described here. Following is a description of the substitution ratio matrix 310 creation sequence of the embodiment, and of a sequence for creating an ink generation point limit parameter based on the substitution ratio matrix 310, followed in sequence by descriptions of the dynamic model used in the smoothing process (smoothing/optimization process), of the processing sequence of the smoothing process, and of the specifics of the optimization process.

### (2) Substitution Ratio Matrix Creation Sequence

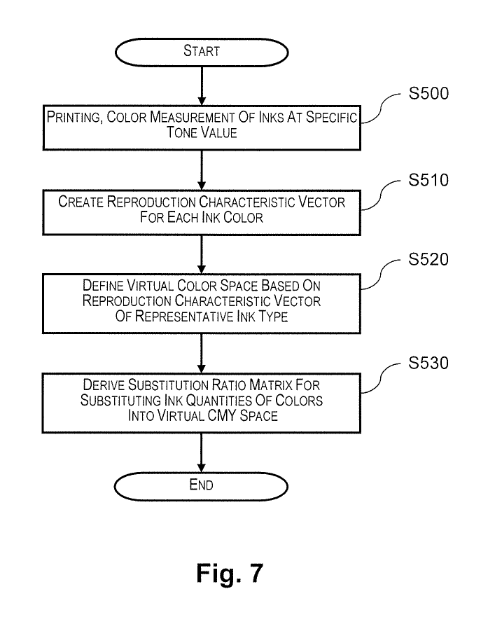

FIG. 7 is a flowchart showing a sequence for creating a substitution ratio matrix. In Step S500, for each of the ink colors installed in the printer, a specific ink tone value is printed and the printed results are measured with a colorimeter. The color measurement values obtained here are acquired using a chroma value space which is a device-independent color space; according to the present embodiment, the value is obtained as an L*a*b* value. Where the printer is capable, for example, of printing 256 tones, any tone from 0 to 255 may be used as the specific ink tone value. However, the specific tone value must be the same tone value for each color of ink.

In Step S510, a vector representing production of each color is created. The production characteristic vector is able to represent, in the L*a*b* space, the chroma value of paper white and the color measurement value obtained for any specific ink quantity tone value, in terms of a difference vector. Of course, the origin of the vector is not limited to paper white, and some other point could be chosen instead. Production characteristic vectors created in this way are vectors that represent production characteristics of each ink, and hereinbelow shall be termed production characteristic vectors. Ordinarily, the relationship of chroma values to ink quantity tone values is a non-linear one; in the present embodiment, however, because the production characteristics of the inks are represented by production characteristics of specific ink quantity tone values, the relationship is unaffected by this non-linearity. Therefore, in the smoothing process to be discussed later, by smoothing the lattice point distribution in the virtual CMY space it is possible to obtain a smooth lattice point distribution of excellent tonality in a chroma value space such as the L*a*b* space as well.

In Step S520, three types of ink are assigned to represent the virtual color space. The three types of ink assigned here constitute a dimension of the workspace in which the smoothing process discussed later will take place. Ordinarily, the three primary colors of the subtractive color model, namely, the three colors dark cyan (C), dark magenta (M), and yellow (Y) are selected, and production characteristic vectors which are color measurement values obtained for a specific ink quantity tone value of these three colors are utilized to formulate unit vectors which serve as a basis for a virtual color space. Likewise, in the present embodiment, these three colors are selected and the virtual color space is termed the virtual CMY space. In the following description, the virtual dark cyan, virtual dark magenta, and virtual yellow which are the components of the virtual CMY space shall be represented respectively as V_{C}, V_{M}, and V_{Y}, and the lattice points designated by these components shall be termed virtual CMY.

Of course, provided that the combination is one that can provide the basis needed to represent a three-dimensional color space, the virtual color space may be formulated based on unit vectors of any three colors selected from among the ink types installed in the printer, namely, C, M, Y, K, Lc, Lm, Lk, Llk, Or, and Gr.

In Step S530, the substitution ratio matrix 310 for substituting ink quantities of the colors into a virtual CMY space is created. First, a substitution matrix M for transforming CMY production characteristic vectors into base vectors in the virtual CMY space can be represented by Equation (1) below.

$$\begin{matrix}Equation ( 1 ) & \\ M = ( \begin{matrix}{xc}^{t} & {xm}^{t} & {xy}^{t}\end{matrix} ) = ( \begin{matrix}xc 1 & xm 1 & xy 1 \\ xc 2 & xm 2 & xy 2 \\ xc 3 & xm 3 & xy 3\end{matrix} ) \\ ( \begin{matrix}xc = ( xc 1 , xc 2 , xc 3 ) \\ xm = ( xm 1 , xm 2 , xm 3 ) \\ xy = ( xy 1 , xy 2 , xy 3 )\end{matrix} ) & ( 1 )\end{matrix}$$

In Equation (1) above, xc is the production characteristic vector for C ink, xm is the production characteristic vector for M ink, and xy is the production characteristic vector for Y ink. The “t” superscript to the right side of the vectors denotes matrix-vector transposition, and indicates that the column vector is one obtained by transposition of the production characteristic vectors.

The substitution matrix M represented in the above manner can be viewed as a matrix for transforming the unit vectors U_{C}, U_{M}, U_{Y} of the virtual CMY space to the production characteristic vectors xc, xm, xy, as shown by Equation (2) below.

$$\begin{matrix}Equation ( 2 ) & \\ \begin{matrix}M \cdot {U}_{C} = ( \begin{matrix}xc 1 & xm 1 & xy 1 \\ xc 2 & xm 2 & xy 2 \\ xc 3 & xm 3 & xy 3\end{matrix} ) ( \begin{matrix}1 \\ 0 \\ 0\end{matrix} ) = {( \begin{matrix}xc 1 & xc 2 & xc 3\end{matrix} )}^{t} \\ M \cdot {U}_{M} = ( \begin{matrix}xc 1 & xm 1 & xy 1 \\ xc 2 & xm 2 & xy 2 \\ xc 3 & xm 3 & xy 3\end{matrix} ) ( \begin{matrix}0 \\ 1 \\ 0\end{matrix} ) = {( \begin{matrix}xm 1 & xm 2 & xm 3\end{matrix} )}^{t} \\ M \cdot {U}_{Y} = ( \begin{matrix}xc 1 & xm 1 & xy 1 \\ xc 2 & xm 2 & xy 2 \\ xc 3 & xm 3 & xy 3\end{matrix} ) ( \begin{matrix}0 \\ 0 \\ 1\end{matrix} ) = {( \begin{matrix}xy 1 & xy2 & xy 3\end{matrix} )}^{t}\end{matrix} \} & ( 2 )\end{matrix}$$

Equation (2) above means that the inverse matrix M⁻¹ is a matrix for normalizing the production characteristic vectors of the colors C, M, and Y which are the bases of the virtual CMY space, to unit vectors which are the bases of the virtual CMY space; vectors obtained through transformation of the production characteristic vectors of the inks of each color by the inverse matrix M⁻¹ are substitution ratio vectors that substitute ink quantities of each color for virtual CMY. The substitution ratio vectors obtained for the colors in this way may be arrayed in a substitution ratio matrix X shown by Equation (3) below. This substitution ratio matrix X serves as the substitution ratio matrix 310 provided to the converter 300 discussed previously.

$$\begin{matrix}Equation ( 3 ) & \\ ( \begin{matrix}{V}_{C} \\ {V}_{M} \\ {V}_{Y}\end{matrix} ) = X ( \begin{matrix}{I}_{C} \\ {I}_{Lc} \\ {I}_{M} \\ {I}_{Lm} \\ {I}_{Y} \\ {I}_{K} \\ {I}_{Lk} \\ {I}_{Llk} \\ {I}_{Or} \\ {I}_{Gr}\end{matrix} ) \\ ( X = ( \begin{matrix}1 & 0.56 & 0 & 0.012 & 0 & 0.57 & 0.38 & 0.13 & - 0.14 & 0.41 \\ 0 & - 0.056 & 1 & 0.48 & 0 & 0.50 & 0.33 & 0.12 & 0.82 & - 0.18 \\ 0 & 0.0053 & 0 & - 0.035 & 1 & 0.53 & 0.37 & 0.15 & 0.61 & 0.24\end{matrix} ) ) & ( 3 )\end{matrix}$$

In Equation (3) above, I_{C}, I_{M}, I_{Y}, I_{K}, I_{Lc}, I_{Lm}, I_{Lk}, I_{Llk}, I_{Or}, and I_{Gr} denote ink quantities of the colors at lattice points in the ink quantity space. According to the substitution ratio matrix X shown by Equation (3), the ink quantity data can be substituted for virtual CMY.

In the substitution ratio matrix X and the substitution ratio vectors that make up this matrix, negative values are permissible as vector elements, as shown by the bracketed expression below Equation (3). The printer according to the present embodiment includes the special inks Or and Gr in addition to CMY dark inks and single-color inks such as Lc, Lm, Lk, and Llk, the reason being that in the virtual CMY space formulated utilizing the CMY production characteristic vectors shown in FIGS. 3, 4, and 5, some of the areas that are represented by the special inks can only be represented in a format that includes virtual CMY negative values. By thus permitting negative values in the virtual CMY, it is possible to represent the characteristics that the special inks are intended to express.

### (3) Creation Sequence for Control Parameters of Ink Generation Point

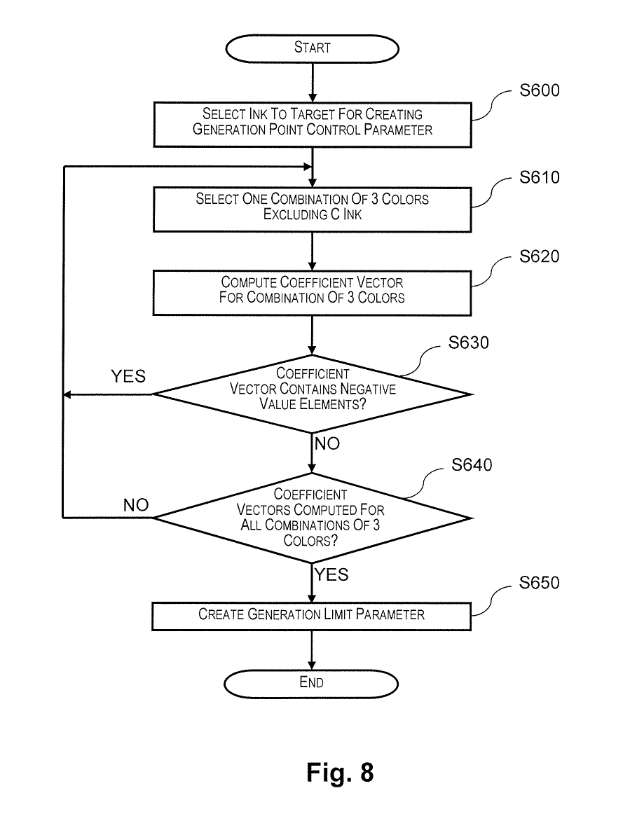

Control parameters for generation points of inks are created utilizing the substitution ratio matrix X that was created in the above manner. FIG. 8 is a flowchart showing the sequence for creating an ink generation point control parameter. In Step S600, one ink is selected as an object for creation of an ink generation point control parameter. Here, an example in which C ink has been selected is described.

In Step S610, one combination of three colors is selected from among all of the inks exclusive of the C ink. In the present embodiment, because ten colors of ink are installed in the printer, the number of possible combinations of three colors is ₉C₃=84. In Step S610, one of these 84 combinations is selected and targeted for the process of Steps S620 to S640 below. In the present embodiment, an example in which an ink combination of Lc, M, Lm has been selected is described.

In Step S620, a coefficient vector a represented by Equation (4) below is computed for the selected three colors.

$$\begin{matrix}Equation ( 4 ) & \\ α = {N}^{- 1} \cdot x \\ ( x = ( \begin{matrix}1 \\ 0 \\ 0\end{matrix} ) , α = ( \begin{matrix}α 1 \\ α 2 \\ α 3\end{matrix} ) , N = ( \begin{matrix}0.56 & 0 & 0.012 \\ - 0.056 & 1 & 0.48 \\ 0.0053 & 0 & - 0.035\end{matrix} ) ) & ( 4 )\end{matrix}$$

In Equation (4) above, x is a C ink substitution ratio vector; N is a partial substitution ratio matrix that combines the substitution ratio vectors of the aforementioned three selected colors; and α is a coefficient vector representing the vector x, which is the C ink substitution ratio vector, based on the substitution ratio vectors of the three colors selected in the aforementioned Step S610. Specifically, this coefficient vector α shows the combination ratio (usage proportion) of each ink, when the C ink substitution ratio vector x (which is one of the unit vectors of the virtual CMY space) is to be substituted by the three inks that were selected in Step S610. Specifically, a positive usage proportion indicates that substitution is possible, and a negative one means that substitution is not possible.

In Step S630, it is determined whether the coefficient vector a includes any elements having negative values. If the coefficient vector a includes any elements having negative values it cannot serve as a basis for generation control parameter creation, and therefore the routine returns to Step S610 and selects the next set of three colors; whereas if the coefficient vector a does not include elements having negative values, the routine advances to Step S640 and creates the generation control parameter. However, optionally, in consideration of factors such as computational errors or color measurement errors, negative values having small absolute values that correspond to errors caused by these factors may be permitted, so that the routine may advance to Step S640 nevertheless.

In Step S640, it is determined whether computation of the coefficient vector a has been carried out for all combinations of three colors. If computations are completed, the routine advances to Step S650, or if computations are not yet completed, the process of Steps S610 to S640 is executed repeatedly until coefficient vector computation and determination of whether negative value elements are included is completed for all other combinations of three colors.

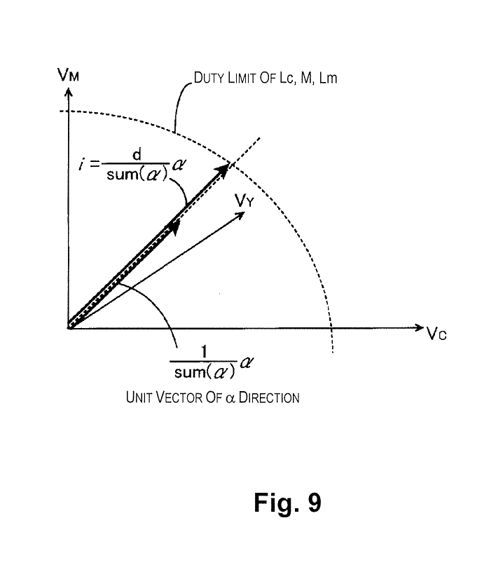

In Step S650, a C ink generation limit parameter is created. FIG. 9 is a diagram showing a relationship of the coefficient vector α and a duty limit when C ink is substituted by a combination of three colors. The relationship shown in the drawing may be represented by Equation (5) below.

$$\begin{matrix}Equation ( 5 ) & \\ ( \begin{matrix}{i}_{1} \\ {i}_{2} \\ {i}_{3}\end{matrix} ) = \frac{d}{sum ( α )} ( \begin{matrix}{α}_{1} \\ {α}_{2} \\ {α}_{3}\end{matrix} ) & ( 5 )\end{matrix}$$

In the above Equation (5), i₁, i₂, and i₃ denote maximum ink quantities that may be used if it is assumed that the aforementioned three colors of ink alone are used up to a duty limit d; α₁, α₂, and α₃ denote elements of the coefficient vector α; and sum(α) denotes the sum of the elements of the coefficient vector α. Hereinafter, the vector expressed by the maximum ink quantities i₁, i₂, and i₃ of these three colors shall be denoted as i. It will be appreciated from the above Equation (5) that vector i indicates the maximum ink quantity able to be substituted when substituting the aforementioned combination of three colors for C ink. It will also be understood from the above Equation (5) that the vector i is a constant multiple of the coefficient vector α.

Next, a vector in the virtual CMY space when C ink is substituted by maximum ink quantities of the aforementioned combination of three colors is derived. This vector v can be represented by Equation (6) below.

$$\begin{matrix}Equation ( 6 ) & \\ v = N ( \begin{matrix}{i}_{1} \\ {i}_{2} \\ {i}_{3}\end{matrix} ) = N \frac{d}{sum ( α )} α = N \frac{d}{sum ( α )} {N}^{- 1} x = \frac{d}{sum ( α )} x & ( 6 )\end{matrix}$$

In Equation 6 above, the vector v is expressed as the product of a partial substitution ratio matrix N composed of base vectors of the aforementioned combination of three colors, and the aforementioned maximum ink quantity vector. It will be appreciated from Equation (6) above that vector v has the same orientation as the substitution ratio vector x.

A scale factor β for scaling from the substitution ratio vector x to vector v is derived as shown by Equation 7 below.

$$\begin{matrix}Equation ( 7 ) & \\ β = \frac{v}{x} = \frac{N \cdot i}{N \cdot α} = \frac{i}{α} = \frac{\frac{d}{sum ( α )} α}{α} = \frac{d}{sum ( α )} & ( 7 )\end{matrix}$$

The scale factor β derived in this manner indicates the maximum possible scale factor when the C ink is substituted by a combination of three colors; this scale factor β represents the maximum ink quantity at which the C ink may be substituted by the selected combination of three colors. When respective scale factors β are derived for the aforementioned 84 possible combinations, the maximum scale factor β in the C ink single-color duty limit indicates the maximum ink quantity that may be substituted when substituting other inks for the C ink. In the example described above, the scale factor β of the maximum substitutable ink quantity is derived for the C ink, but the scale factor β can be derived by a similar sequence for each of the other inks.

When the scale factor β is computed, in the case of light color ink or special color ink, there are instances in which the maximum scale factor β within the single-color duty limit is zero, which means that no substitutable ink combination exists. Specifically, because negative values are disallowed in the coefficient vector α, as mentioned previously, even when carrying out creation of nonspecific ink generation point control parameters that are not tied to any particular ink set, it is possible to create ink generation point control parameters that feature special handling of special color inks. That is, there is no need to impose area limits on the special color inks Or and Gr. Moreover, because negative values are disallowed in the coefficient vector α, it is possible to avoid limiting the use of special color inks which have been provided to ensure a full color gamut.

In the optimization process discussed later, which is carried out utilizing ink quantity generation limit parameters created in the above manner, it is determined whether or not to target the selected ink type (in this case, C ink) for the optimization process, depending on whether Equation (8) below is satisfied.

$$\begin{matrix}Equation ( 8 ) & \\ \frac{u \cdot x}{{\vert x \vert}^{2}} < β \\ ( {u}^{′} = \vert u \vert cos θ \frac{x}{\vert x \vert} = \vert u \vert ( \frac{u}{\vert u \vert} \cdot \frac{x}{\vert x \vert} ) \frac{x}{\vert x \vert} = \frac{u \cdot x}{{\vert x \vert}^{2}} x ) & ( 8 )\end{matrix}$$

In the above Equation (8), u is a vector representing a target virtual CMY, discussed later, and u′ is a vector derived through projection of the vector u in the direction of the substitution ratio vector x.

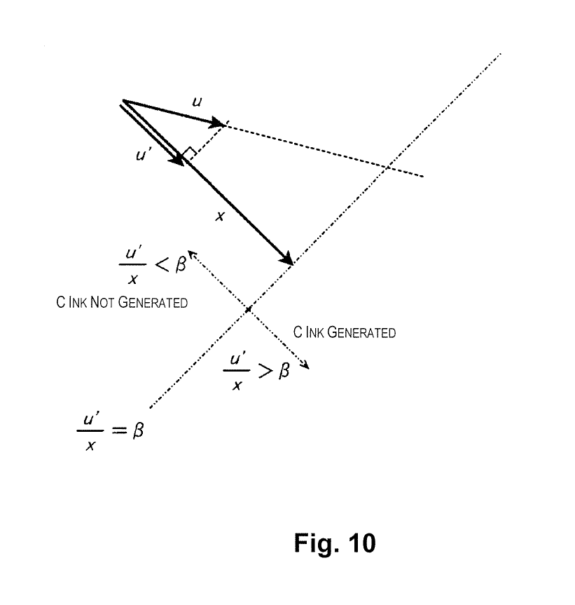

FIG. 10 is a drawing explaining the above Equation (8). As shown in the drawing, where the vector resulting from projection of the vector u in the direction of the C ink substitution ratio vector x is denoted as vector u′, when the ratio of the vector u′ to the vector x is equal to or less than the scale factor β, this means that the C ink needed to represent the target virtual CMY with ink types corresponding to the bases of the virtual CMY space (in the present embodiment, C, M, and Y) can be represented through substitution by other inks. Accordingly, when the aforementioned ratio is equal to or less than the scale factor β, C ink will be detargeted from the optimization process, so that C ink is not generated (C ink tone values are set to zero). On the other hand, if the aforementioned ratio is greater than the scale factor this means that when target virtual CMY are represented with ink types corresponding to the bases of the virtual CMY space (in the present embodiment, C, M, and Y), representation is not possible without using C ink. Accordingly, when the aforementioned ratio is greater than the scale factor β, the C ink will be targeted for the optimization process, allowing the C ink to be generated (the C ink tone values to be set to non-zero values).

By using the aforementioned ink quantity generation limit parameters to limit in advance the ink types targeted for the optimization process, it is possible to improve the speed of the optimization process while effectively avoiding graininess. Of course, if it is not necessary to force substitution of other inks for C ink right up to the limit, the limit imposed by β may be relaxed by using a predetermined constant r, as shown by Equation (9) below.

$$\begin{matrix}Equation ( 9 ) & \\ \frac{u \cdot x}{{\vert x \vert}^{2}} < r β \\ ( 0 < r < 1 ) \\ ( 4 ) Dynamic Model & ( 9 )\end{matrix}$$

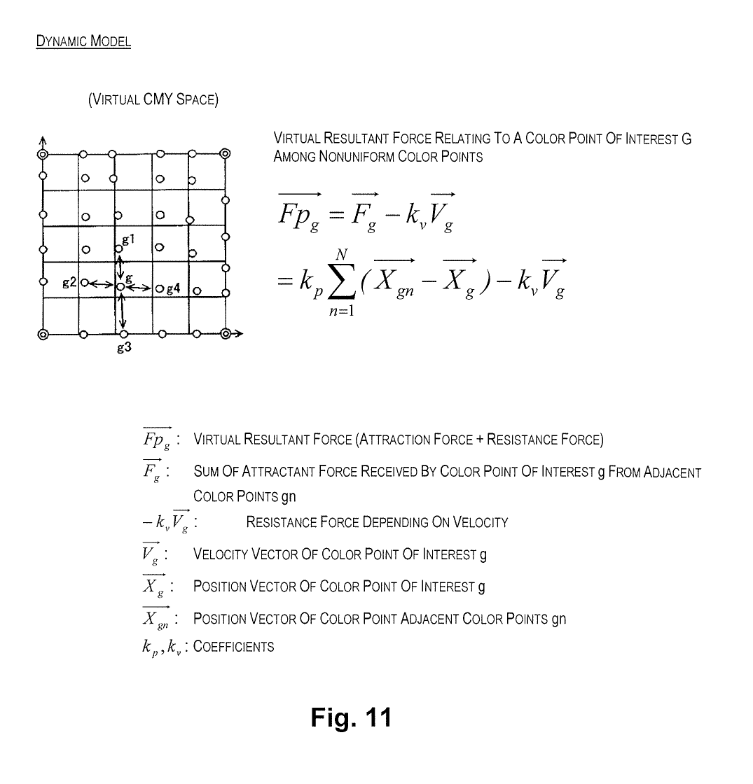

FIG. 11 is an illustration showing a dynamic model utilized in the smoothing process (smoothing/optimization process) of the present embodiment. Here, a plurality of color points (white circles and double circles) are shown arrayed in a virtual CMY color space. However, for convenience of description, the color point arrangement is depicted two-dimensionally. This dynamic model assumes that virtual force Fp_{g} in the following equation relates to a particular color point of interest g.

$$\begin{matrix}Equation ( 10 ) & \\ \begin{matrix}\vec{{Fp}_{g}} = \vec{F} - {k}_{v} \vec{{V}_{g}} \\ = {k}_{p} {\sum }_{n = 1}^{N} ( \vec{{X}_{gn}} - \vec{{X}_{g}} ) - {k}_{v} \vec{{V}_{g}}\end{matrix} & ( 10 )\end{matrix}$$

Here, F_{g} is the sum total value of attraction forces that the color point of interest g receives from adjacent color points gn (n is 1 to N); V_{g} is a velocity vector of the color point of interest g; −kᵥ V_{g} is resistance force depending on velocity; X_{g} is a position vector of the color point of interest g; X_{gn} is a position vector of an adjacent color point gn; and kₚ, k_{g} are coefficients. The coefficients kₚ, k_{g} are set to constant values beforehand. The arrows that indicate the vectors are omitted in the text.

This model is a damped oscillation model of mass points linked to one another by a spring. Specifically, the virtual total force Fp_{g} relating to the color point of interest g is the sum total value of spring force F_{g} which increases with increasing distance between the color point of interest g and the adjacent color point gn, and resistance force −kᵥ V_{g} which increases with increasing velocity of the color point of interest g. According to this dynamic model, the position vector X_{g} and the velocity vector V_{g} are sequentially calculated over infinitesimal time increments for each color point after initial values for the position vector X_{g} and the velocity vector V_{g} are set. The initial values of the velocity vectors V_{g} of a plurality of color points are set to zero, for example. By utilizing such a dynamic model, it is possible to gradually shift the color points and obtain a smooth color point distribution.

Forces other than spring force F_{g} and resistance force −kᵥ V_{g} may be used as forces relating to the color points. For example, the various other forces described in co-pending Japanese Laid-open Patent Publication No. 2006-197080 may be utilized in this dynamic model as well. When applying the dynamic model to shift the color points, it is optionally possible to treat specific color points as constrained points which are not shifted by the dynamic model.

### (5) Process Sequence of Smoothing Process (Smoothing/Optimization Process)

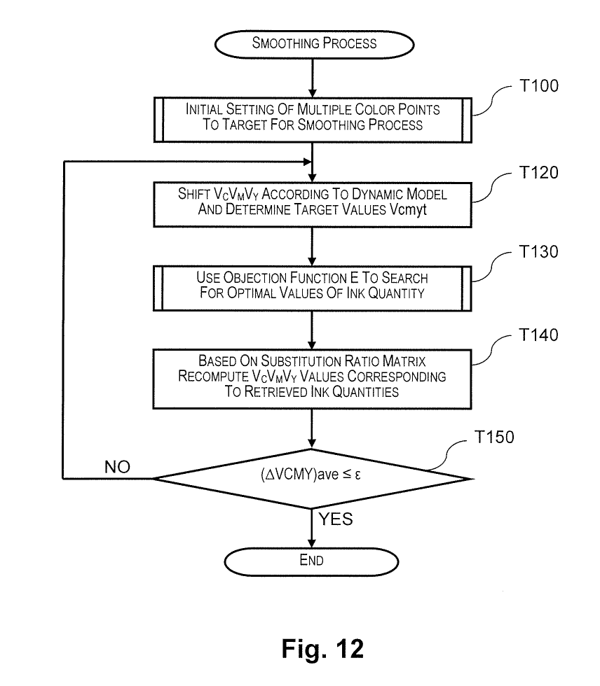

FIG. 12 is a flowchart showing a typical process sequence of the smoothing process (Step S300 of FIG. 2). In Step T100, the smoothing process initial value setting module 120 (FIG. 1) initially sets a plurality of color points targeted for the smoothing process.

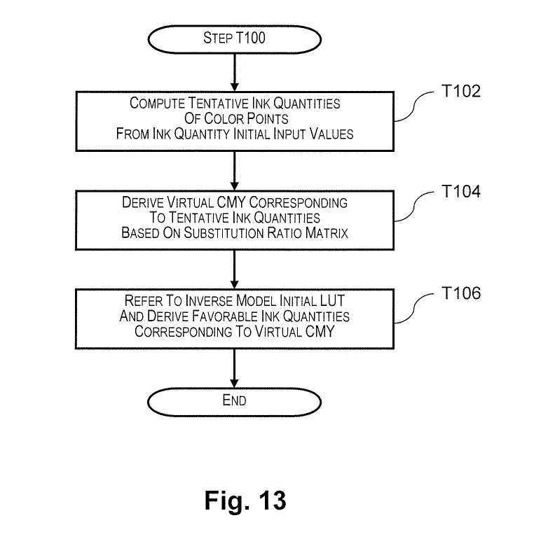

FIG. 13 is a flowchart showing in detail the sequence of Step T100. In Step T102, tentative ink quantities of color points targeted for the smoothing process are determined from initial input values of ink quantities (FIG. 3(B), FIG. 5(B)). For example, in a 3D-LUT smoothing process, a tentative ink quantity I_{(R,G,B)} for input lattice points is determined according to Equation (11) and Equation (12) below.

$$\begin{matrix} Equation ( 11 ) & \\ {I}_{j ( R , G , B )} = ( 1 - {r}_{R} ) ( 1 - {r}_{G} ) ( 1 - {r}_{B} ) {I}_{j ( 0 , 0 , 0 )} + ( 1 - {r}_{R} ) ( 1 - {r}_{G} ) {r}_{B} {I}_{j ( 0 , 0 , 255 )} + ( 1 - {r}_{R} ) {r}_{G} ( 1 - {r}_{B} ) {I}_{j ( 0 , 255 , 0 )} + {r}_{R} ( 1 - {r}_{G} ) ( 1 - {r}_{B} ) {I}_{j ( 255 , 0 , 0 )} + ( 1 - {r}_{R} ) {r}_{G} {r}_{B} {I}_{j ( 0 , 255 , 255 )} + {r}_{R} ( 1 - {r}_{G} ) {r}_{B} {I}_{j ( 255 , 0 , 255 )} + {r}_{R} {r}_{G} ( 1 - {r}_{B} ) {I}_{j ( 255 , 255 , 0 )} + {r}_{R} {r}_{G} {r}_{B} {I}_{j ( 255 , 255 , 255 )} & ( 11 ) \\ Equation ( 12 ) & \\ {r}_{R} = \frac{R}{255} , {r}_{G} = \frac{G}{255} , {r}_{B} = \frac{B}{255} & ( 12 )\end{matrix}$$

Here, I_{(R,G,B)} represents the ink quantity of the ink set as a whole, for the RGB value of an input lattice point (in the example of FIG. 3, the ink quantity of ten types of ink). Ink quantities for input lattice points that have an RGB value of 0 or 255 are values that were input by the user beforehand in Step S200 of FIG. 2. According to Equation (11) and Equation (12), it is possible to derive a tentative ink quantity I_{(R,G,B)} for any RGB value.

In a 4D-LUT smoothing process, a tentative ink quantity I_{(C,M,Y,K)} for each input lattice point is determined according to Equation (13) and Equation (14) below.

$$\begin{matrix} Equation ( 13 ) & \\ {I}_{j ( C , M , Y , K )} = ( 1 - {r}_{C} ) ( 1 - {r}_{M} ) ( 1 - {r}_{Y} ) ( 1 - {r}_{K} ) {I}_{j ( 0 , 0 , 0 , 0 )} + ( 1 - {r}_{C} ) ( 1 - {r}_{M} ) ( 1 - {r}_{Y} ) {r}_{K} {I}_{j ( 0 , 0 , 0 , 255 )} + ( 1 - {r}_{C} ) ( 1 - {r}_{M} ) {r}_{Y} ( 1 - {r}_{K} ) {I}_{j ( 0 , 0 , 255 , 0 )} + ( 1 - {r}_{C} ) {r}_{M} ( 1 - {r}_{Y} ) ( 1 - {r}_{K} ) {I}_{j ( 0 , 255 , 0 , 0 )} + {r}_{C} ( 1 - {r}_{M} ) ( 1 - {r}_{Y} ) ( 1 - {r}_{K} ) {I}_{j ( 255 , 0 , 0 , 0 )} + ( 1 - {r}_{C} ) ( 1 - {r}_{M} ) {r}_{Y} {r}_{K} {I}_{j ( 0 , 0 , 255 , 255 )} + ( 1 - {r}_{C} ) {r}_{M} ( 1 - {r}_{Y} ) {r}_{K} {I}_{j ( 0 , 255 , 0 , 255 )} + {r}_{C} ( 1 - {r}_{M} ) ( 1 - {r}_{Y} ) {r}_{K} {I}_{j ( 255 , 0 , 0 , 255 )} + ( 1 - {r}_{C} ) {r}_{M} {r}_{Y} ( 1 - {r}_{K} ) {I}_{j ( 0 , 255 , 255 , 0 )} + {r}_{C} ( 1 - {r}_{M} ) {r}_{Y} ( 1 - {r}_{K} ) {I}_{j ( 255 , 0 , 255 , 0 )} + {r}_{C} {r}_{M} ( 1 - {r}_{Y} ) ( 1 - {r}_{K} ) {I}_{j ( 255 , 255 , 0 , 0 )} + ( 1 - {r}_{C} ) {r}_{M} {r}_{Y} {r}_{K} {I}_{j ( 0 , 255 , 255 , 255 )} + {r}_{C} {r}_{M} ( 1 - {r}_{Y} ) {r}_{K} {I}_{j ( 255 , 255 , 0 , 255 )} + {r}_{C} {r}_{M} {r}_{Y} ( 1 - {r}_{K} ) {I}_{j ( 255 , 255 , 255 , 0 )} + {r}_{C} ( 1 - {r}_{M} ) {r}_{Y} {r}_{K} {I}_{j ( 255 , 0 , 255 , 255 )} + {r}_{C} {r}_{M} {r}_{Y} {r}_{K} {I}_{j ( 255 , 255 , 255 , 255 )} & ( 13 ) \\ Equation ( 14 ) & \\ {r}_{C} = \frac{C}{255} , {r}_{M} = \frac{M}{255} , {r}_{Y} = \frac{Y}{255} , {r}_{K} = \frac{K}{255} & ( 14 )\end{matrix}$$

As can be understood from Equation (13), because there are 16 initial input values for 4D-LUT ink quantities, setting the initial input values is complicated. Accordingly, another approach is to select, as input lattice points for setting initial input values for ink quantities, for example, only the eight vertex points of K=0, i.e., the eight vertex points (C,M,Y,K)=(0, 0, 0, 0), (0, 0, 255, 0), (0, 255, 0, 0), (0, 255, 255, 0), (255, 0, 0, 0), (255, 0, 255, 0), (255, 255, 0, 0), and (255, 255, 255, 0); and one vertex point of K=255, for example, (C,M,Y,K)=(0, 0, 0, 255), and to determine the ink quantity of the K=255 color point with Equation (15) or Equation (16) below.

Equation (15)

I_{(C,M,Y,255)}=f_{D1}(I_{(C,M,Y,0)})+I_{(0,0,0,255)} (15)

Equation (16)

I_{(C,M,Y,255)}=f_{D2}(I_{(C,M,Y,0)}+I_{(0,0,0,255)}) (16)

Here, I_{(C,M,Y,0)} is an ink quantity computed by an equation similar to Equation (11) above, from initial input values of ink quantities at the eight vertex points of K=0. The function f_{D1} of Equation (15) is a function that, if the sum total value of the value I_{(C,M,Y,O)} and the value I_{(0,0,0,255)} exceeds the ink duty limit value, subtracts the value I_{(C,M,Y,O)} so that the ink quantity I_{(C,M,Y,255)} is held below the ink duty limit value. The function f_{D2} of Equation (16) is a function that, if the sum total value of the value I_{(C,M,Y,O)} and the value I_{(0,0,0,255)} exceeds the ink duty limit value, subtracts the entire sum total value (I_{(C,M,Y,O)}+I_{(0,0,0,255)}) so that the ink quantity I_{(C,M,Y,255)} is held below the ink duty limit value. Where an ink quantity Iⱼ (including I_{j(R,G,B)}, ΔIⱼ, Iⱼᵣ, and hⱼ) is given without the subscript j, this signifies a matrix (vector) having ink quantities Iⱼ of the inks as the row elements.

In Step T104 of FIG. 13, virtual CMY corresponding to the tentative ink quantities are derived using the converter 300. This computation can be represented by Equation (17) or Equation (18) below.

$$\begin{matrix}Equation ( 17 ) & \\ ( \begin{matrix}{V}_{C ( R , G , B )} \\ {V}_{M ( R , G , B )} \\ {V}_{Y ( R , G , B )}\end{matrix} ) = X \cdot {I}_{( R , G , B )} & ( 17 ) \\ Equation ( 18 ) & \\ ( \begin{matrix}{V}_{C ( C , M , Y , K )} \\ {V}_{M ( C , M , Y , K )} \\ {V}_{Y ( C , M , Y , K )}\end{matrix} ) = X \cdot {I}_{( C , M , Y , K )} & ( 18 )\end{matrix}$$

Here, V_{C(R,G,B)}, V_{M(R,G,B)}, V_{Y(R,G,B)}, V_{C(C,M,Y,K)}, V_{M(C,M,Y,K)}, and V_{Y(C,M,Y,K)} indicate virtual CMY values subsequent to transformation; and X signifies transformation by the substitution ratio matrix 310 discussed above. It can be understood from these equations that the virtual CMY values subsequent to transformation are associated with RGB values or CMYK values that are base LUT input values.

In Step T106 of FIG. 13, the virtual CMY values obtained in Step T104 are retransformed to ink quantities using the inverse model initial LUT 410 (FIG. 3(A)). Here, the reason for retransformation to ink quantities using the inverse model initial LUT 410 is that the ink quantity initial input values or the tentative ink quantities that were determined in Step T102 are not necessarily ink quantities favorable as ink quantities for reproducing virtual CMY values. On the other hand, the ink quantities that are registered in the inverse model initial LUT 410 are considered favorable in terms of picture quality and the like, and therefore by using the LUT to retransform the virtual CMY values to ink quantities, ink quantities that are favorable for realizing the virtual CMY values may be obtained as initial values. However, Step T106 may be omitted.

As a result of the process of Step T100 discussed above, the following initial values are determined for color points that are targeted for the smoothing process.

(1) Values of the base LUT input lattice points: (R,G,B) or (C,M,Y,K). (2) Initial coordinate values of color points of the virtual CMY space corresponding to the input lattice points: (V_{C(R,G,B)}, V_{M(R,G,B)}, V_{Y(R,G,B)}) or (V_{C(C,M,Y,K)}, V_{M(C,M,Y,K)}, V_{Y(C,M,Y,K)}). (3) Initial ink quantities corresponding to the input lattice points: I_{(R,G,B)} or I_{(C,M,Y,K)}.

From the preceding discussion it can be understood that the initial value setting module 120 has the function of setting initial values that relate to other input lattice points from input initial values that relate to a set of representative input lattice points. Optionally, the initial value setting module 120 may be included in the smoothing process module 130.

In Step T120 of FIG. 12, the color point shift module 132 shifts color points in the virtual CMY space in accordance with the dynamic model discussed above.

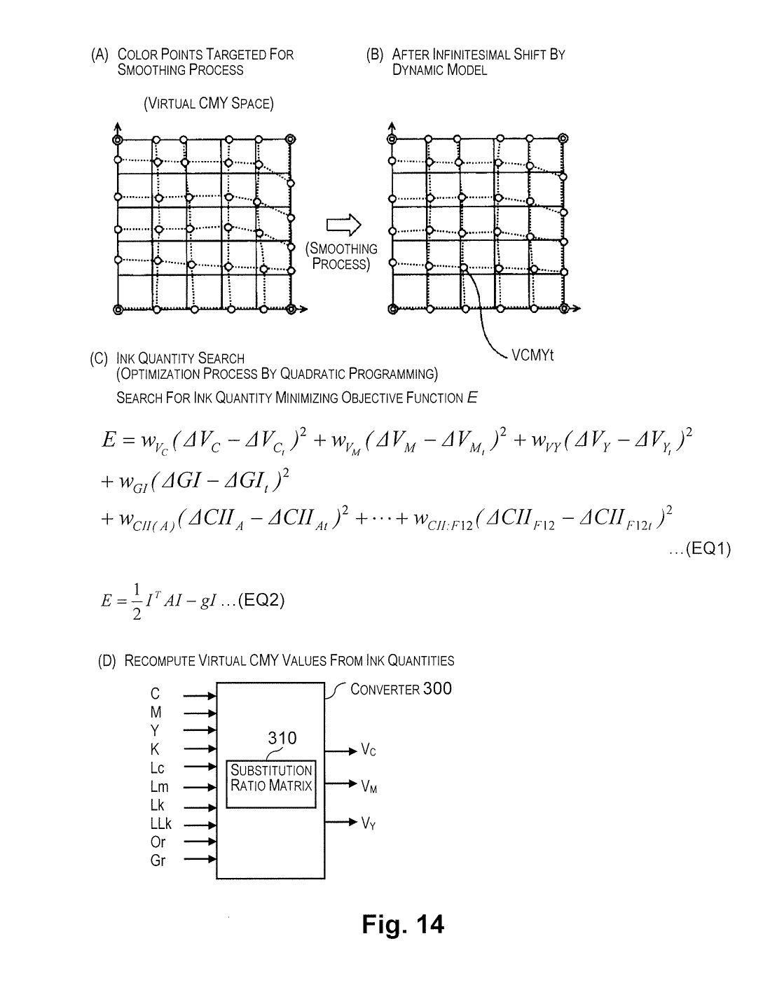

FIGS. 14 (A) to (D) are illustrations showing the process specifics of Steps T120 to T150 of FIG. 12. As shown in FIG. 14(A), prior to the smoothing process, there is considerable bias in the distribution of the color points. FIG. 14(B) shows the locations of the color points after an infinitesimal time increment. The virtual CMY values of the color points subsequent to this shift are termed “target values (VCMYₜ)”. The modifier “target” refers to the fact that these target values VCMYₜ are used as reference values during the process of searching for optimal values of ink quantities, discussed below.

In Step T130, the ink quantity optimization module 134, using a preset objective function E, searches for optimal values of ink quantities for the target values VCMYₜ (see FIG. 14(C)). Optimization using this objective function E involves determining the optimal ink quantities to be those which, of the ink quantities for reproducing virtual CMY values that approximate the coordinates VCMYₜ of the color points subsequent to shifting by an infinitesimal amount in the dynamic model, are the ink quantities that afford the smallest possible sum of squared errors of a plurality of parameters ΔV_{C}, ΔV_{M}, ΔV_{Y}, ΔGI, ΔCII, and ΔTI. The search for optimal ink quantities starts from the initial ink values of the input lattice points that were set in Step T100. Consequently, the ink quantities obtained by the search represent corrected values of these initial ink quantities. As will be discussed in detail later, the objective function E which is given by Equation (EQ1) can be written as a function of quadratic form relating to an ink quantity vector I, as shown by Equation (EQ2). Ink quantity optimization is executed according to quadratic programming using this objective function E of quadratic form. The process of Step T130 which is executed by the ink quantity optimization module 134 constitutes the optimization step in the present embodiment. The details of the sequence of Step T130 and the specifics of the objective function E are discussed below.

In Step T140 of FIG. 12, the virtual CMY values corresponding to the ink quantities Iⱼ retrieved in Step T130 are recomputed by the converter 300 (see FIG. 14(D)). The reason for recomputing the virtual CMY values at this point is that because the retrieved ink quantities Iⱼ are ink quantities that minimize the objective function E, the virtual CMY values reproduced by those ink quantities Iⱼ will diverge somewhat from the target values VCMYₜ of the optimization process. The virtual CMY values recomputed in this fashion are used as the coordinates of the color points subsequent to shifting.

In Step T150, it is determined whether the average amount of shift (ΔVCMY)ₐᵥₑ of the color point coordinate values is equal to or less than a preset threshold value ε. If the average amount of shift (ΔVCMY)ₐᵥₑ is greater than the threshold value c, the routine returns to Step T120, and the smoothing process of Steps T120 to T150 continues. On the other hand, if the average amount of shift (ΔVCMY)ₐᵥₑ is equal to or less than the threshold value ε, the smoothing process terminates because the distribution of color points is considered to be sufficiently smooth. The threshold value ε is a value that is determined experimentally beforehand to be appropriate.

In this way, according to the typical smoothing process (smoothing/optimization) process of the present embodiment, an optimization method is used to search for optimal ink quantities corresponding to shifted color points, while shifting the color points over infinitesimal time intervals by a dynamic model. These processes continue until the amount of shift for the color points is sufficiently small. As a result, as shown in FIG. 3(C), it is possible through the smoothing process to obtain a smooth color point distribution.

### (6) Specifics of Optimization Process

The objective function E of the optimization process (see FIG. 14(C)) may be represented using a Jacobian matrix J relating to virtual CMY values (which are a function of ink quantity) and to picture quality evaluation indices. The Jacobian matrix J may be expressed by Equation (19) below, for example.

$$\begin{matrix}Equation ( 19 ) & \\ J = ( \begin{matrix}\frac{\partial {V}_{C}}{\partial {I}_{1}} & \frac{\partial {V}_{C}}{\partial {I}_{2}} & ⋯ & \frac{\partial {V}_{C}}{\partial {I}_{10}} \\ \frac{\partial {V}_{M}}{\partial {I}_{1}} & \frac{\partial {V}_{M}}{\partial {I}_{2}} & ⋯ & \frac{\partial {V}_{M}}{\partial {I}_{10}} \\ \frac{\partial {V}_{Y}}{\partial {I}_{1}} & \frac{\partial {V}_{Y}}{\partial {I}_{2}} & ⋯ & \frac{\partial {V}_{Y}}{\partial {I}_{10}} \\ \frac{\partial GI}{\partial {I}_{1}} & \frac{\partial GI}{\partial {I}_{2}} & ⋯ & \frac{\partial GI}{\partial {I}_{10}} \\ \frac{\partial {CII}_{A}}{\partial {I}_{1}} & \frac{\partial {CII}_{A}}{\partial {I}_{2}} & ⋯ & \frac{\partial {CII}_{A}}{\partial {I}_{10}} \\ ⋮ & ⋮ & & ⋮ \\ \frac{\partial {CII}_{F 12}}{\partial {I}_{1}} & \frac{\partial {CII}_{F 12}}{\partial {I}_{2}} & ⋱ & \frac{\partial {CII}_{F 12}}{\partial {I}_{10}} \\ \frac{\partial TI}{\partial {I}_{1}} & \frac{\partial TI}{\partial {I}_{2}} & ⋯ & \frac{\partial TI}{\partial {I}_{10}}\end{matrix} ) & ( 19 )\end{matrix}$$

The first to third rows of the right side of Equation (19) show values derived by partial differentiation of virtual CMY values with individual ink quantities Iⱼ. The fourth and subsequent rows show values derived by partial differentiation, with individual ink quantities Iⱼ, of picture quality evaluation indices (a Graininess Index (GI), a Color Inconstancy Index (CII), and a total ink quantity TI) that represent the picture quality of a color patch printed with one set of ink quantities Iⱼ (j=1 to 10). The picture quality evaluation indices GI, CII, and TI are indices for which smaller values tend to be associated with better picture quality of the color patch reproduced with an ink quantity Iⱼ.

Using the converter 300, the virtual CMY values are transformed from ink quantities Iⱼ with Equation (20) below.

$$\begin{matrix}Equation ( 20 ) & \\ ( \begin{matrix}{V}_{C} \\ {V}_{M} \\ {V}_{Y}\end{matrix} ) = X \cdot I & ( 20 )\end{matrix}$$

Likewise, the picture quality evaluation indices GI, CII ordinarily can be respectively represented as functions of the ink quantity Iⱼ.

Equation (21)

GI=f_{GI}(I) (21)

Equation (22)

CIIᵢₗₗ=f_{CII(ill)}(I) (22)

Equation (23)

TI=ΣIⱼ (23)

The subscript “ill” of the Color Inconstancy Index CIIᵢₗₗ of Equation (22) represents the type of illuminant. In Equation (19) above, the types of illuminant used are the standard illuminant A and the standard illuminant F12. An example of a Color Inconstancy Index computation method is given below; however, it is possible for any number of indices that relate to one or a plurality of types of standard illuminant to be used as the Color Inconstancy Index CII.

The Graininess Index GI may be computed using various types of graininess prediction models, and may be computed with Equation (24) below, for example.

Equation (24)

GI=a_{L}∫\sqrt{WS(u)}VTF(u)du (24)

Here, aL is a luminance correction coefficient, WS(u) is the Wiener spectrum of an image indicated by the halftone data utilized to print the color patch, VTF(u) is a visual spatial frequency characteristic, and u is a spatial frequency. The halftone data is determined from the ink quantity Iⱼ of the color patch by a halftoning process (one identical to the halftoning process executed by the printer 10). While Equation (24) above is represented in one dimension, it is a simple matter to compute the spatial frequency of a two-dimensional image as the spatial frequency function. As methods for computation of the Graininess Index, for example, the method disclosed in the co-pending Japanese Unexamined Patent Application (Translation of PCT Application) 2007-511161 or the method disclosed in Makoto Fujino, Image Quality Evaluation of Inkjet Prints, Japan Hardcopy '99, p. 291 to 294, may be used.

The Color Inconstancy Index CII is given, for example, by Equation (25) below.

$$\begin{matrix}Equation ( 25 ) & \\ CII = [ {( \frac{Δ {L}^{*}}{2 {S}_{L}} )}^{2} + {( \frac{Δ {C}_{ab}^{*}}{2 {S}_{C}} )}^{2} + {( \frac{Δ {H}_{ab}^{*}}{{S}_{H}} )}^{2} ] & ( 25 )\end{matrix}$$

Here, ΔL* is the luminance difference of a color patch observed under two different observation parameters (under different illuminants), ΔC*_{ab} is the chroma difference, and ΔH*_{ab} is the hue difference. When computing the Color Inconstancy Index CII, L*a*b* values obtained under the two different observation parameters are transformed to a standard observation parameter (e.g., observation under a standard illuminant D65) using a chromatic-adaptation transform (CAT). With regard to the CII, reference may be made to Billmeyer and Saltzman's Principles of Color Technology, 3rd Edition, John Wiley & Sons, Inc., 2000, p. 129, pp. 213 to 215.

Of the plurality of components (also called elements) of the Jacobian matrix J, the component relating, for example, to the V_{C} value is given by Equation (26).

$$\begin{matrix}Equation ( 26 ) & \\ \frac{\partial {V}_{C}}{\partial {I}_{j}} = \frac{X ( {I}_{r} + {h}_{j} ) - X ( {I}_{r} )}{{h}_{j}} & ( 26 )\end{matrix}$$

Here, X(Iᵣ+hⱼ) and X(Iᵣ) are values obtained by transformation from the ink quantity I to V_{C} by the converter 300; Iᵣ is the current value of the ink quantity I (the ink quantity prior to the smoothing/optimization process); and hⱼ is an infinitesimal variation of the j-th ink quantity Iⱼ. Other components are represented in the same form.

The objective function E for optimization is given, for example, by Equation (27) below.

$$\begin{matrix} Equation ( 27 ) & \\ E = {{w}_{{V}_{C}} ( Δ {V}_{C} - Δ {V}_{Ct} )}^{2} + {{w}_{{V}_{M}} ( Δ {V}_{M} - Δ {V}_{Mt} )}^{2} + {{w}_{{V}_{Y}} ( Δ {V}_{Y} - Δ {V}_{Yt} )}^{2} + {{w}_{GI} ( Δ GI - Δ {GI}_{t} )}^{2} + {{w}_{CII ( A )} ( Δ {CII}_{A} - Δ {CII}_{At} )}^{2} + … + {{w}_{CII ( f 12 )} ( Δ {CII}_{F 12} - Δ {CII}_{F 12 t} )}^{2} + {{w}_{TI} ( Δ TI - Δ {TI}_{t} )}^{2} & ( 27 )\end{matrix}$$

Here, w_{VC}, w_{VM}, etc., which appear at the beginning of each term on the right side are weighting factors for the terms. The weighting factors w_{VC}, w_{VM} . . . for the terms are preset.

The first term w_{VC}(ΔV_{C}−ΔV_{Ct})² on the right side in Equation (27) is a squared error relating to variation quantities ΔV_{C}, ΔV_{Ct} of virtual cyan V_{c}. These variation quantities ΔV_{C}, ΔV_{Ct} are given by the following equations.

$$\begin{matrix}Equation ( 28 ) & \\ Δ {V}_{C} = \sum \frac{\partial {V}_{C}}{\partial {I}_{j}} Δ {I}_{j} = \sum \frac{\partial {V}_{C}}{\partial {I}_{j}} ( {I}_{j} - {I}_{jr} ) & ( 28 ) \\ Equation ( 29 ) & \\ Δ {V}_{Ct} = {V}_{Ct} - X ( {I}_{r} ) & ( 29 )\end{matrix}$$

The partial differentiation value on the right side in Equation (28) above is a value given by a Jacobian matrix (Equation (19)), Iⱼ is the ink quantity obtained as a result of the optimization process, and Iⱼᵣ is the current ink quantity. The first variation quantity ΔV_{C} is a quantity derived by subjecting the ink quantity variation quantity ΔIⱼ, attributed to the optimization process, to linear transformation with a partial differentiation value which is a component of the Jacobian matrix. The second variation quantity ΔV_{Ct}, on the other hand, is the differential of the target value V_{Ct} obtained in the smoothing process of Step T120, and virtual cyan V_{C}(Iᵣ) given by the current ink quantity Iⱼᵣ. It is possible to think of the second variation quantity ΔV_{Ct} as being the differential of the V_{C} values before and after the smoothing process.

The second and subsequent terms on the right side in Equation (27) are likewise given by equations analogous to Equations (28) and (29) above. Specifically, the objective function E is given as the sum of the squared error of the first variation quantities ΔV_{C}, ΔV_{M}, ΔV_{Y}, ΔGI . . . obtained through linear transformation by a component of a Jacobian matrix of the ink quantity variation ΔIⱼ attributed to the optimization process, and second variation quantities ΔV_{Ct}, ΔV_{Mt}, ΔV_{Yt}, ΔGIₜ . . . observed before and after the smoothing process in relation to parameters V_{C}, V_{M}, V_{Y}, GI . . . .

Using a matrix, it is possible for the first variation quantities ΔV_{C}, ΔV_{M}, ΔV_{Y}, ΔGI . . . to be written in the form of Equation (30) and Equation (31) below.

$$\begin{matrix}Equation ( 30 ) & \\ ( \begin{matrix}Δ {V}_{C} \\ Δ {V}_{M} \\ Δ {V}_{Y} \\ Δ GI \\ Δ {CII}_{A} \\ ⋮ \\ Δ {CII}_{F 12} \\ Δ TI\end{matrix} ) = J \cdot Δ I & ( 30 ) \\ Equation ( 31 ) & \\ Δ I = I - {I}_{r} = ( \begin{matrix}Δ {I}_{1} \\ Δ {I}_{2} \\ ⋮ \\ Δ {I}_{8}\end{matrix} ) & ( 31 )\end{matrix}$$

Using a matrix, Equation (27) above can be denoted as Equation (32).

$$\begin{matrix}Equation ( 32 ) & \\ \begin{matrix}E = {( J ( I - {I}_{r} ) - Δ M )}^{T} {W}_{M} ( J ( I - {I}_{r} ) - Δ M ) \\ = ( {I}^{T} {J}^{T} - ( {I}_{r}^{T} {J}^{T} + Δ {M}^{T} ) ) {W}_{M} ( JI - ( {JI}_{r} + Δ M ) ) \\ = {I}^{T} {J}^{T} {W}_{M} JI - 2 ( {I}_{r}^{T} {J}^{T} + Δ {M}^{T} ) {W}_{M} JI + \\ ( {I}_{r}^{T} {J}^{T} + Δ {M}^{T} ) {W}_{M} ( {JI}_{r} + Δ M )\end{matrix} & ( 32 )\end{matrix}$$

Here, T represents the transposition of the matrix. The matrix W_{M} is a diagonal matrix (see Equation (33)) with weighting factors positioned at respective diagonal elements, and the matrix ΔM is a target variation quantity vector (see Equation (34)) relating to the parameters.

$$\begin{matrix}Equation ( 33 ) & \\ ( \begin{matrix}{w}_{{V}_{C}} & 0 & & & ⋯ & & & 0 \\ & {w}_{{V}_{M}} & & & & & & \\ & & {w}_{{V}_{Y}} & & & & & \\ & & & {w}_{GI} & & & & ⋮ \\ ⋮ & & & & {w}_{CII ( A )} & & & \\ & & & & & ⋱ & & \\ & & & & & & {w}_{CII ( F 12 )} & 0 \\ 0 & & & ⋯ & & & 0 & {w}_{TI}\end{matrix} ) & ( 33 ) \\ Equation ( 34 ) & \\ Δ M = ( \begin{matrix}Δ {V}_{Ct} \\ Δ {V}_{Mt} \\ Δ {V}_{Yt} \\ Δ {GI}_{t} \\ Δ {CII}_{At} \\ ⋮ \\ Δ {CII}_{F 12 t} \\ Δ {TI}_{t}\end{matrix} ) = ( \begin{matrix}{V}_{Ct} - X ( {I}_{r} ) \\ {V}_{Mt} - X ( {I}_{r} ) \\ {V}_{Yt} - X ( {I}_{r} ) \\ {GI}_{t} - GI ( {I}_{r} ) \\ {CII}_{At} - {CII}_{A} ( {I}_{r} ) \\ ⋮ \\ {CII}_{F 12 t} - {CII}_{F 12} ( {I}_{r} ) \\ {TI}_{t} - \sum {I}_{jr}\end{matrix} ) = const . & ( 34 )\end{matrix}$$

The right side of Equation (34) is the differential of the target values relating to the parameters V_{C}, V_{M}, V_{Y}, CII . . . (also called “elements”), and parameter values given by the current ink quantity Iᵣ. Among the target values for the various parameters, target values VCMYₜ for the virtual CMY are determined by the smoothing process (Step T120). There are any number of determination methods for the target variation quantities ΔGIₜ, ΔCIIₜ, ΔTIₜ, which are derived from target values for the picture quality evaluation indices and from current picture quality evaluation indices. The first method is one in which predetermined constants (e.g., ΔGIₜ=−2, ΔCCIₜ=−1, ΔTIₜ=1) are used as the target variation quantities ΔGIₜ, ΔCIIₜ, ΔTIₜ. The reason for using negative values as constants is that these picture quality evaluation indices are indices for which smaller values indicate higher picture quality. In preferred practice, the target value GIₜ for the Graininess Index GI is zero. The second method involves defining the target values GIₜ, CIIₜ, TIₜ as functions of the target values VCMYₜ of the virtual CMY values. Because the target values of the parameters are determined prior to the optimization process in the above manner, all of the components of the target variation quantity vector ΔM are constants.

Of the terms in the right side in Equation (32), the third term (Iᵣ^{T}J^{T}+ΔM^{T})W_{M}(JIᵣ+ΔM) is a constant, because the term does not include the ink quantity I obtained as a result of the optimization process. Ordinarily, the objective function E used for optimization does not require a constant term. Accordingly, eliminating the constant term from Equation (32) and multiplying the whole expression by ½ gives the following Equation (35).

$$\begin{matrix}Equation ( 35 ) & \\ E = \frac{1}{2} {I}^{T} {J}^{T} {W}_{M} JI - ( {I}_{r}^{T} {J}^{T} + Δ {M}^{T} ) {W}_{M} JI & ( 35 )\end{matrix}$$

Here, where a matrix A and a vector g are defined as in Equation (36) and Equation (37) below, Equation (35) above may be written as Equation (38).

$$\begin{matrix}Equation ( 36 ) & \\ A = {J}^{T} {W}_{M} J & ( 36 ) \\ Equation ( 37 ) & \\ g = ( {I}_{r}^{T} {J}^{T} + Δ {M}^{T} ) {W}_{M} J & ( 37 ) \\ Equation ( 38 ) & \\ E = \frac{1}{2} {I}^{T} AI - gI & ( 38 )\end{matrix}$$

The objective function E given by Equation (38) can be understood to be of quadratic form relating to an ink quantity vector I that is obtained through optimization. Equation (EQ1) and Equation (EQ2) shown in FIG. 14(C) are respectively identical to Equation (27) and Equation (38).

It is possible to employ quadratic programming as the optimization method because the optimization process of the present embodiment employs the objective function E of quadratic form as shown in Equation (38). Here, “quadratic programming” refers to quadratic programming in a narrowly defined sense that excludes sequential quadratic programming. Through utilization of quadratic programming employing an objective function of quadratic form, it is possible for the process to be appreciably faster, as compared with the case of quasi-Newton methods, sequential quadratic programming, or other nonlinear programming methods.

The search for ink quantities through the optimization process in the present embodiment is executed under the following parameters.

(Optimization parameter) The objective function E must be minimized.

(Constraining parameter 1) The ink duty limit must be observed.

(Constraining parameter 2) The ink generation point control parameter must be observed.

It is possible to use as the ink duty limit value, for example, a maximum permissible value of the ink quantity of each individual ink, or a maximum permissible value of the total ink quantity. For example, where the ink quantity of each ink is represented on 8 bits, the maximum permissible value of the ink quantity Iⱼ of the ten different individual inks may be set to 180, and the maximum permissible value of the total ink quantity Σ Iⱼ may be set to 240.

The ink duty limit can be expressed by Equation (39) below.

Equation (39)

b^{T}I=(1 0 . . . 0)I≦lim, (39)

Here, vector b is a coefficient for identifying ink types targeted by the duty limit, and the elements of the vector are either 0 or 1. For example, in the case of a duty limit relating to a single type of ink, only one element of vector b is a 1. On the other hand, in the case of a duty limit relating to the total ink quantity of all the inks, all of the elements of vector b are 1's. In the right side of Equation (39), lim₁ is a duty limit value.

Ink quantities Iⱼ have the constraint that they cannot be negative. This nonnegative limit is expressed by Equation (40) below.

Equation (40)

b_{nz}^{T}I=(1 0 . . . 0)I≧0 (40)

When the aforementioned Equation (39) and Equation (40) are combined, the ink duty limit is given by Equation (41) below.

$$\begin{matrix}Equation ( 41 ) & \\ BI = ( \begin{matrix}1 & 0 & ⋯ & 0 \\ 0 & 1 & & ⋮ \\ ⋮ & & ⋱ & 0 \\ 0 & ⋯ & 0 & 1 \\ 1 & 1 & 1 & 1 \\ - 1 & 0 & ⋯ & 0 \\ 0 & - 1 & & ⋮ \\ ⋮ & & ⋱ & 0 \\ 0 & ⋯ & 0 & - 1\end{matrix} ) I \leq ( \begin{matrix}{lim}_{I 1} \\ ⋮ \\ ⋮ \\ {lim}_{I 8} \\ {lim}_{total} \\ 0 \\ ⋮ \\ ⋮ \\ 0\end{matrix} ) & ( 41 )\end{matrix}$$

The constraint represented by Equation (41) is a linear inequality constraint. Ordinarily, it is possible for quadratic programming to be executed under a linear constraint. Specifically, according to the optimization process of the present embodiment, quadratic programming is executed under the constraint of Equation (41) using the objective function E of quadratic form given by Equation (38) above, in order to search for optimal ink quantities. As a result, it is possible for ink quantity searches to be executed rapidly, while rigorously satisfying this linear constraint.

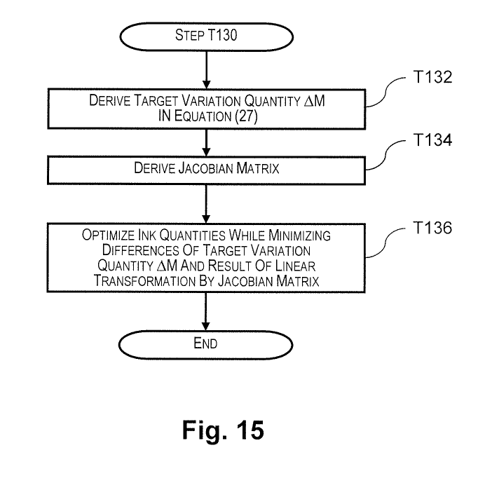

FIG. 15 is a flowchart showing in detail the sequence of the optimization process (Step T130 of FIG. 12). In Step T132, first, the target variation quantity ΔM given by Equation (34) is derived. As noted above, this target variation quantity ΔM is determined based on the target values CMYₜ obtained in Step T120 (smoothing process) and the current ink quantity Iᵣ.

In Step T134, the Jacobian matrix J given by Equation (19) above is computed. As depicted by way of example in Equation (26) above, the components of the Jacobian matrix J are values that are computed in relation to the current values Iᵣ of ink quantities (values prior to smoothing/optimization).

In Step T136, optimization of ink quantities is carried out so as to minimize differences between the results of linear transformation by the Jacobian matrix J, i.e., ΔV_{C}, ΔV_{M}, ΔV_{Y}, ΔGI . . . and the target variation quantity ΔM (V_{C}, ΔV_{M}, ΔV_{Y}, ΔGIₜ . . . ). This optimization is accomplished by executing quadratic programming using the objective function E of quadratic form given by Equation (38) above.

As discussed previously in the flowchart of FIG. 12, if subsequent to the optimization process of Step T130 it is decided that convergence is insufficient, the smoothing process (Step T120) and the optimization process (Step T130) are executed again. During this time, values obtained from the previous smoothing/optimization process are used as the initial values of the smoothing/optimization process. This repeated processing is not essential, and it is sufficient for the smoothing/optimization process to be executed at least once.

Thus, according to the present embodiment, by searching for optimal ink quantities through execution of quadratic programming using an objective function E of quadratic form, it is possible for ink quantity searches to be executed rapidly. Actual measurements taken by the inventors have shown that the process finishes in about one-tenth the time required with conventional quasi-Newton methods.

### (7) Modified Examples

It is to be understood that the embodiments described hereinabove are not limiting of the invention, and that various other modes are possible without departing from the scope of the invention, such as the following modifications for example.

### (7-1) Modified Example 1

In the embodiment above, a process utilizing a dynamic model was employed as the smoothing process, but other types of smoothing process may be employed instead. For example, it is possible to employ a smoothing process in which intervals between adjacent color points are measured, and the individual intervals are adjusted to bring them into approximation with the average value thereof.

### (7-2) Modified Example 2

The term “ink” in the present specification is not limited to liquid ink of the sort used in inkjet printers, offset printers, and the like, but is used in a broad sense to include toners used in laser printers. It is possible to employ terms such as “color material,” “coloring material,” or “coloring agent” as other terms comparably broad in meaning to “ink” in this sense.

### (7-3) Modified Example 3

Whereas the embodiment above is described in relation to a method and a device for creating a color transformation table, it is also possible for the present invention to be applied to a printing device manufacturing system provided with an incorporating portion that incorporates a color transformation table obtained in this way into the printing device. The color transformation table creation device for creating the color transformation table may be included in this printing device manufacturing system, or included in another system or device. The incorporating portion of the manufacturing system may be realized as a printer driver installer (install program), for example.

### (7-4) Modified Example 4

Whereas the embodiment above is described in relation to a method and a device for creating a color transformation table, it is also possible for the present invention to be realized as the color transformation table per se obtained in the above manner; or as a printing device provided with a storage portion for storing a color transformation table, and adapted to transform and print out input print data based on the color transformation table.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for manufacturing a printing device provided with a color transformation table for transformation of coordinate values in an input color coordinate system indicated by input image data to ink quantity sets in an ink color coordinate system composed of a plurality of inks, the method comprising:
performing a linear transformation for transforming ink quantities in the ink color coordinate system corresponding to the coordinate values in the input color coordinate system into a virtual color space with reference to substitution ratio vectors for transforming the ink quantities into the virtual color space, the virtual color space having ink quantity vectors oriented in mutually different directions in the respective chroma value spaces of the plurality of inks as basis vectors;
optimizing the ink quantities by carrying out a plurality of iterations of optimization using a predetermined objective function that is represented by a combination of a plurality of individually weighted picture quality evaluation indices in the virtual color space;
creating a color transformation table for transformation of the coordinate values in the input color coordinate system to the ink quantities in the ink color coordinate system, based on the optimized ink quantities; and
recording the color transformation table in computer-readable form to a recording medium of the printing device.

2. The method for manufacturing a printing device according to claim 1, wherein
negative values are allowed as elements of the substitution ratio vectors.

3. A printing device comprising:
inks for printing; and
a recording medium recorded a color transformation table for transformation of coordinate values in an input color coordinate system indicated by input image data to ink quantity sets in an ink color coordinate system composed of a plurality of the inks;
wherein the color transformation table is created by,
performing a linear transformation for transforming ink quantities in the ink color coordinate system corresponding to the coordinate values in the input color coordinate system into a virtual color space with reference to substitution ratio vectors for transforming the ink quantities into the virtual color space, the virtual color space having ink quantity vectors oriented in mutually different directions in the respective chroma value spaces of the plurality of inks as basis vectors,
optimizing the ink quantities by carrying out a plurality of iterations of optimization using a predetermined objective function that is represented by a combination of a plurality of individually weighted picture quality evaluation indices in the virtual color space and
creating a color transformation table for transformation of the coordinate values in the input color coordinate system to the ink quantities in the ink color coordinate system, based on the optimized ink quantities.

4. The printing device according to claim 3, wherein
negative values are allowed as elements of the substitution ratio vectors.

5. A printing method with a printing device provided with a color transformation table for transformation of coordinate values in an input color coordinate system indicated by input image data to ink quantity sets in an ink color coordinate system composed of a plurality of inks, the method comprising:
performing a linear transformation for transforming ink quantities in the ink color coordinate system corresponding to the coordinate values in the input color coordinate system into a virtual color space with reference to substitution ratio vectors for transforming the ink quantities into the virtual color space, the virtual color space having ink quantity vectors oriented in mutually different directions in the respective chroma value spaces of the plurality of inks as basis vectors;
optimizing the ink quantities by carrying out a plurality of iterations of optimization using a predetermined objective function that is represented by a combination of a plurality of individually weighted picture quality evaluation indices in the virtual color space;
creating a color transformation table for transformation of the coordinate values in the input color coordinate system to the ink quantities in the ink color coordinate system, based on the optimized ink quantities; and
printing with the inks based on the color transformation table.

6. The printing method according to claim 5, wherein
negative values are allowed as elements of the substitution ratio vectors.
